(19) United States
(12) Patent Application Publication
(10) Pub. No.: US 2005/0038868 A1
(43) Pub. Date: Feb. 17, 2005

(54) Web form host

(76) Inventor: Jeffrey J. Spicer, Morgan's Point, TX (US)

Correspondence Address: PEACOCK MYERS AND ADAMS P C, P O BOX 26927, ALBUQUERQUE, NM, 871256927, US

(21) Appl. No.: 10/848,804

(22) Filed: May 18, 2004

Related U.S. Application Data
(60) Provisional application No. 60/482,163, filed on Jun. 23, 2003.
(60) Provisional application No. 60/472,021, filed on May 19, 2003.

(51) Int. Cl. G06F 15/16

(52) U.S. Cl. 709/217

(57) ABSTRACT

A system for creating, delivering, presenting, manipulating and managing by a user or through a remote process a multiplicity of framed content in a remote workspace. The content is preferably specified in XML and is of any type, dynamically created, and asynchronously delivered to any workspace instance.

### CROSS-REFERENCE TO RELATED APPLICATIONS

This application claims the benefit of the filing of U.S. Provisional Patent Application Ser. Nos. 60/472,021 and 60/482,163, both entitled “Web Form Host”, filed on May 19, 2003 and Jun. 23, 2003, respectively, and the specifications thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

A compact disc appendix is included containing computer program code listings pursuant to 37 C.F.R. 1.52(e) and is hereby incorporated by reference in its entirety. The total number of compact discs is 1 including 40 files and 2,978,261 bytes. The files included on the compact disc are listed in a file entitled “dir_s” on the compact disc. Because of the large number of files contained on the compact disc, the required listing of file names, dates of creation and sizes in bytes is included in the file dir_s on the compact disk and incorporated by reference herein. Note that because Omnis Studio does not maintain source code in ASCII text format, Adobe Acrobat files resulting from the “Print Class” command within Omnis Studio as well as text files resulting from such command, which text files contain some printer specific artifacts.

### COPYRIGHTED MATERIAL

© 2004 Jeffrey J. Spicer. A portion of the disclosure of this patent document and of the related applications listed above contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field)

The field of the invention relates to a next generation system for creating, delivering, presenting and managing content interfaces for remote processes or web services.

2. Description of Related Art

Context of the Invention

Information systems invoked a transformation in the way we interact with our tasks. Through the introduction and use of multiple graphical user interfaces the desktop environment where we interact and interface with our separate work tasks has become a collage of isolated and mainly static, pre-formed, graphical user interfaces.

The invention supersedes the need for independently produced, pre-formed, static graphical user interfaces, and creates a next generation desktop environment.

The invention is a system and a set of methods that creates a browser based client encapsulated workspace where form based content (content) is presented in graphical user interface frames. The server portion of the system allows—e.g., through a XML (Extensible Markup Language) document specification—the dynamic production and asynchronous delivery of all graphical user interface content to frames in any user workspace. All properties of the new or existing content and the behavior of its parent frame may be dynamically modified at run-time. The combination allows the next generation's enterprise workflow processes to generate the content and send it to a workspace and then orchestrate concurrently with the user the allowable user interaction and behavior of the interface and thus with the content during the interfaces lifespan as part of the workflow process.

Multiple Static & User Driven Interfaces

In this generation's static interface and user driven architecture, one interactively multitasks through a multitude of event driven, pre-built, graphical user interfaces installed on powerful user specific desktop workstations that define one's workspace. At any one time, the user's workspace may contain many separate interfaces that are isolated from one another.

These interfaces are driven and managed by the user. The user, knowing the tasks to be performed, opens the required interfaces and externally prioritizes the order in which the tasks are completed/attended to. It requires prior knowledge of the workflow process, the task, the interface, and its functionality. Once the tasks are completed the interfaces are closed and the workspace is idle.

Encapsulated Workspace

Although the user has been granted remote access to most of these proprietary static interfaces via remote viewers that import the distant server desktops and/or multiple browser instances displaying portals, forums, email etc and other proprietary isolated services, it is difficult to treat the user's desktop workspace as an encapsulated single entity where the individual interfaces belonging to one task—although from disparate sources and having unique functionality—may be related categorized and prioritized as such.

The requirement for this and the next generation is for a remote encapsulated workspace where the disparate content interfaces can be rendered locally, presented, manipulated and managed as a single entity, and furthermore provided persistence by allowing the users workspace instance to be stored and retrieved.

One object of the invention is to provide a process and system that creates a browser based workspace allowing a user to have interaction with multiple types of content held in a multiplicity of moveable graphical user interface frames. The workspace is encapsulated and allows the content interfaces to be presented, manipulated, and managed as related interfaces. An instance of the workspace can be saved as a whole to disk and restored, rebuilding the workspace instance.

Dynamic Workspace

In the next generation, spurred on by standard protocols, enterprise architectures and dynamic data, interfaces have a requirement that they are dynamically produced. The user, however, still has a static interaction with the overall system. They must initiate an interface and manually retrieve the form content. Once the content is presented, the user must manually refresh the form or page in order for it to reflect any changes in the graphical user interface functionality and behavior, data, as it relates to the dynamic workflow. This is user driven and at odds with the dynamic server driven architectures.

The requirement is for a method of providing the user with multiple graphical user interfaces asynchronously, when the GUI components, interface logic and interactive behavior are only known at run time and can be continually updated at run-time to reflect the changes in the workflow process.

One object of the invention is to provide a process and system that through the specification of content in XML (or like language for specification of content) creates the content and provides it asynchronously to specified user's workspace. Once created all its properties are modifiable by further submitting of XML documents pertaining to the content instance. The creation of content, its delivery, categorization and management into and out of the workspace thus being able to be orchestrated by the user and/or the workflow processes. Through this cycle, the user's workspace and the framed content is—in step with the workflow processes, constantly in flux, dynamic and ongoing.

Definitions

For the purposes of this application, the following italicized terms have the meaning given. Content is any form component. Content Message is a XML (or like language for specification of content) document specifying system properties and behavior as well as the content its behavior and properties. Frame header—specifying through frame properties and behavior how the content can be acted on, how it is categorized, presented and how it relates itself topically to other content and any communications required by the content. A browser includes an HTML (Hypertext Markup Language) parser for displaying GUIs (graphical user interfaces) over the web. Examples of these include but are not limited to Internet Explorer, Netscape, Safari, any Mozilla based browser. A desktop includes the visible work area displayable on the screen of a computer at any given time. The workspace is the interactive space accessible to the user.

A Theme is a collection of user specified colors and layout which in this invention includes the desktop image and the frame properties. Background Image is any type image file whether static or in motion. Number of Desktops is the number of layered desktops. They are created stacked on top of each other. Desktop Names are the names of each individual desktop. Desktop Size Is the virtual size of the desktop. This can be many times the size of the area visible through the browser window. A Frame is a run time container it has in-built graphical properties and behavior for displaying and manipulating the content. Frame Controls are controls that provide specific frame functions that relate to the workspace and the client content. Frame Types (FIG. 13) are frames that have differing properties and behavior. Special Frames are frames that do not exist within the desktop layers but always on top of all desktops and are not visually affected by a desktop change. They also do not scroll as the desktop is scrolled but rather keep their position relative to the browser window. Normal Frames are Frames that exist within the desktop layers and can be moved from one desktop to another and are fixed to a desktop position while the desktop is scrolled. System Form is a Form that will receive special workspace system messages. Client Operating System is the operating system type that the browser is running on such as but not limited to Macintosh, Windows, Linux and Unix. Events are events that are initiated by a user of the workspace via the use of a mouse and/or keyboard and/or events that are initiated by a local or remote application or application component process or user.

Prior Art

Related technologies, which do not provide the capabilities of the present invention, include the following: U.S. Patent Publication 2002/0023111 (web page editor for creating web pages); U.S. Patent Publication 2003/0028562 (document sharing and form creation for Microsoft Office); U.S. Patent Publication 2002/0198935 (form field data validation); U.S. Patent Publication 2002/0198903 (submission of multiple forms); U.S. Patent Publication 2002/0156808 (document sharing and form creation); U.S. Patent Publication 2002/0032706 (web application and workflow design); U.S. Pat. No. 6,529,217 (graphing); U.S. Pat. No. 6,061,695 (windows desktop navigator as hypertext); U.S. Pat. No. 6,161,114 (combining media to display as a single document); U.S. Pat. No. 6,345,278 (form engine); U.S. Pat. No. 6,088,700 (automatic completion of web form); U.S. Pat. No. 6,128,617 (hierarchical linked data representation); U.S. Pat. No. 5,802,514 (creation of entity relationship diagrams using visual editor); U.S. Pat. No. 6,589,290 (automatic completion of web form); and U.S. Pat. No. 6,199,079 (automatic completion of web form).

### BRIEF SUMMARY OF THE INVENTION

The present invention is of a browser based user workspace instance supporting a plurality of moveable frames and layered desktops within a single browser window. In the preferred embodiment, any instance of the environment of the desktops can have a plurality of display, behavioral, dynamic and content specific properties modified at run-time, preferably including one or more of the properties selected from Current Desktop Number, Desktop Height, Desktop Width, Name, Fore Color, Border Color, Pattern, Border Effect, and Desktop Image. Any instance of the frames can support content of any type. Any instance of the content can be provided runtime data storage. Any instance of the frames can support content specific communications. The desktops can be resized to be larger than the viewable space. The desktops can be repositioned under the visible area in the browser window such that any part of the available desktop area may be made visible. The desktops are displayed in the window according to a front and back order wherein a desktop towards the front in the order overlaps any desktops farther back in the order, and wherein the order may be altered. The frames can be repositioned throughout the desktop layers. Any instance of the environment the frames can have a plurality of display properties that may be modified at run time, preferably one or more of the properties selected from the group consisting of Title Bar, Title Bar Text Alignment, Title Bar Text Font, Title Bar Text Font Size, Title Bar Text Font Style, Title Bar Text Color, Title Bar Height, Title Fore Color, Title Bar Gap Size, Title Bar Inner Border, Title Pattern, Title Back Color, Frame Inner Border, Frame Outer Border, Frame Gap Fill Color, Frame Gap Size, Frame Width, and Frame Height. Any instance of the environment the frames can have a plurality of behavioral properties that may be modified at run time, preferably selected from the group consisting of Can Drag/Move, Can Resize, Disable Content Sizing, Bring to Top, Can Be Attached to a Form or Component, Edge Float, Minimizing, and Maximizing. The frames' content may be populated asynchronously from server based content queues. A set of services can allow the frames to exchange messages on the client. A set of services can allow presentation properties of groups of frames to be accessed as unit. The workspace may be saved to a server, and desktops and the frames and their contents may be restored from a saved record. The frames' content can be created dynamically by a form engine. The content is preferably specified by a XML document, preferably wherein one or more form components and specific component properties can be specified by the XML document, preferably selected from the group consisting of the list of properties beginning on page 14 of the specification. Any of the components can also have a plurality of standard properties that may be set, preferably all or some of which can be set at run-time. Form components and specific component methods can be specified by the XML document.

The present invention comprises a system set of methods that together create an event driven user workspace for presenting and managing content. The workspace is a browser based environment composed of multi-layered desktops containing movable frames into which content is retrieved and presented. The user's interaction with the content and the management of the content while in the user's workspace are specified and orchestrated at run time by user events and/or by asynchronous messages to the workspace from a server remote process.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained-by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a schematic diagram of the system architecture of the invention.

FIG. 1 is a flow diagram of the system processes of the invention.

FIG. 2 is a flow diagram of the asynchronous forms process.

FIG. 3 is a flow diagram of the change frame process.

FIG. 4 illustrates the Enter Data process; if a client form ‘A’ has set the enter data state. If an ‘illegal’ event tries to break the enter data state such as the user clicking on form ‘B’ to bring it to top, the workspace does not bring the form to top but rather sends a message to the caller's frame that was stored so that the caller may respond.

FIG. 5 is an illustration of an embodiment of the invention as presented to a remote end user of the present invention.

FIG. 5a is an illustration of a frame of the invention.

FIG. 6 illustrates title controls.

FIG. 7 illustrates the navigation bar of the invention.

FIG. 8 illustrates the theme picker of the invention.

FIGS. 8a and 8b are further illustrations of the theme picker of the invention.

FIG. 9 illustrates the pan manager of the invention.

FIG. 10 illustrates the use of asynchronous forms in the invention.

FIG. 11 illustrates the desktop picker of the invention.

FIG. 12 [reserved]

FIG. 13 illustrates use of a background picture according to the invention; the user may through the use of host methods set each one of the multilayered desktops ‘A’ to have its own background picture or image ‘B’ and ‘C’.

FIG. 14 illustrates desktop scrolling according to the invention; through the use of events the expanded desktop ‘A’ may be scrolled in all directions, which causes the visible area under the browser ‘B’ to scroll.

FIG. 15 illustrates desktop sizing according to the invention; the height and width of the desktop ‘A’ can be expanded ‘B’ to be many times the size of the visible space exposed to the user by the browser window ‘C’.

FIGS. 16a and 16b illustrate desktop switching according to the invention; the desktop that is currently the top desktop (FIG. 16a) ‘B’ of the layered desktops may be switched so that a desktop lower in the stack ‘A’ becomes the top most desktop and therefore the current and visible one (FIG. 16b).

FIG. 17 illustrates frame properties according to the invention are properties that may be assigned to the frames individually and at run time such as, frame title bar color, title height ‘A’, text, text alignment, text color, ‘B’, title gap ‘C’, border gap ‘D’, inner border and outer border styles ‘E’ and multiple controls ‘F’, menu bar ‘H’ and status bar ‘I’.

FIG. 17a shows preferred Frame Types according to the invention; frames are containers for content which have inbuilt properties and behavior which may be added to giving the support for an almost limitless number of frame types and content support, inbuilt behavior and display properties; the user may through the use of a mouse click on an inbuilt frame type button cause a frame to change its desktop scrolling behavior, such as from that of a Normal Frame (FIG. 17c) to that of a Special Frame (FIG. 17b).

FIG. 18a illustrates frame resizing according to the invention; the user may through the use of the mouse click on any edge of the frame ‘A’, ‘B’, ‘C’, ‘D’—including the corners, ‘E’—by holding the mouse button down to drag the frame edges; the frame expands or reduces in size depending on the edge and the direction of the drag; the client form will receive resize messages as the form is resized with parameters that describe the new frame dimensions.

FIG. 18b illustrates frame to form resizing messages.

FIG. 19 is a flow diagram of the change forms desktop process.

FIG. 19a illustrates moving frames throughout the multilayered desktops of the invention; the user may through the use of host methods move frame ‘D’ through the multilayered desktops ‘A’, ‘B’, ‘C’; the form specified as a form manager will receive a message that the form has changed its desktop number, with parameters that contain the forms stub code data.

FIG. 20 is a flow diagram of the close frame process.

FIG. 21 illustrates frame moving/dragging according to the invention. Through the applications use of modified content headers or by the user, through the use of the mouse or other pointing device, move/drag the frame in all directions. Equally the user ‘A’ by clicking on the title bar and while holding the mouse button down dragging the frame; the client form of the frame will receive a message with parameters that describe the new location as the form is dragged.

FIG. 22 is a flow diagram of the bring to top process.

FIGS. 22a and 22b illustrate the frame bring to top aspect of the invention; the user may through the use of the mouse click on any part of an underlying frame ‘A’ bringing it to the top; the client form of the frame that is being brought to top will receive a message and the form that is loosing focus ‘B’ will receive a message.

FIG. 23 is a flow diagram of the minimize/maximize process.

FIG. 23a illustrates minimizing/restoring.

FIG. 23b illustrates maximizing/restoring.

FIGS. 23c and 23d illustrate organizing the display of frames on individual desktops.

FIG. 24 is a flow diagram of workspace saving.

FIG. 25 illustrates the rebuild flag and user key.

FIGS. 26-40 illustrate preferred XML message structures according to the invention.

### DETAILED DESCRIPTION OF THE INVENTION

An implementation of this invention in Omnis Studio is disclosed, but the invention can be employed with other development environments and development languages and application server platforms, includi ng but not limited to, C++, Java, C#, JavaScript, ColdFusion, .NET, Active Server Pages (ASP), JavaServer Pages (JSP), BEA WebLogic and PHP hypertext preprocessor.

Overview

The system allows content to be specified by an XML document and created at run-time. Once created it and any supporting modules are asynchronously delivered to a workspace instance, further XML messages relating to the framed content instance allow any property of the instance to be changed at runtime. The workspace instance supports a plurality of content and may be saved and restored. It allows the user to interact with the content pieces as related pieces.

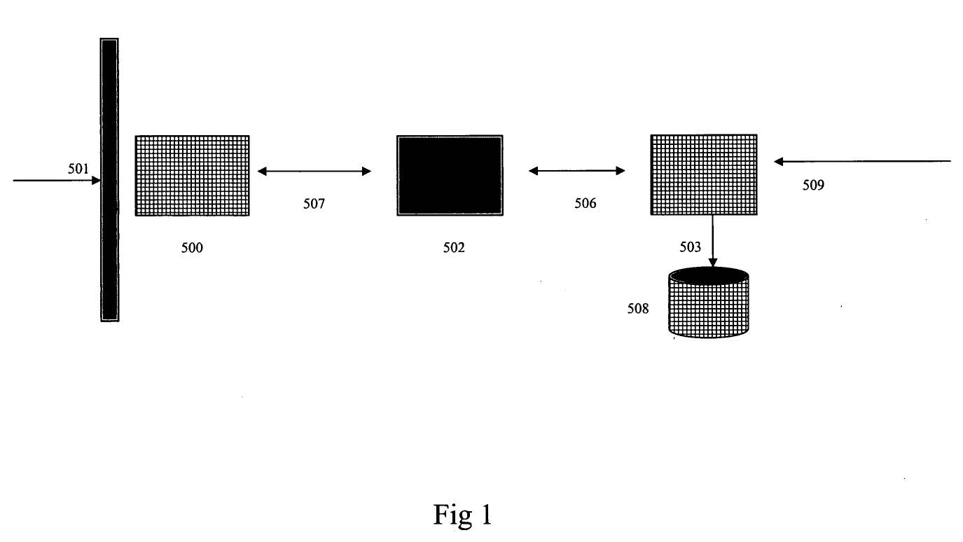

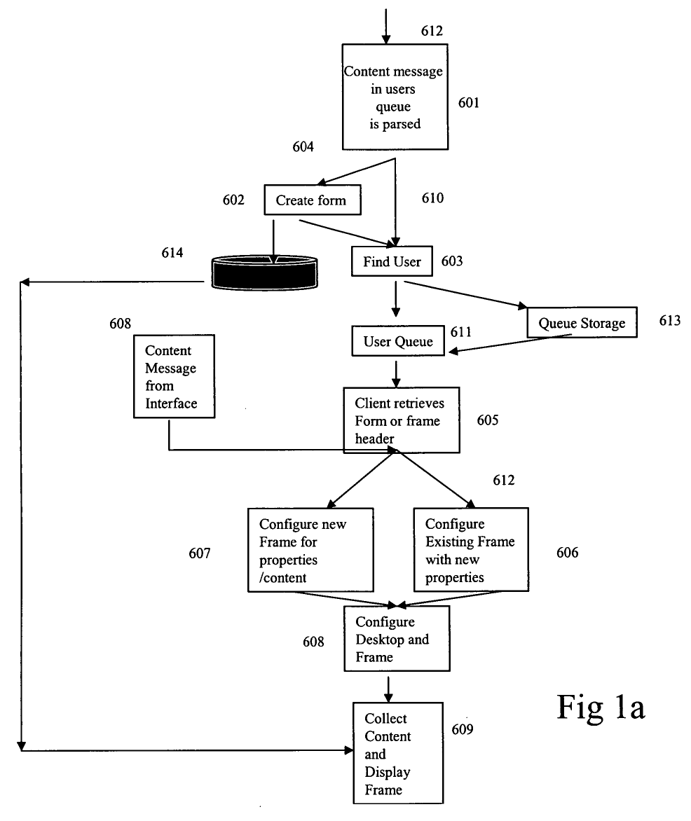

System Architecture (FIG. 1)

In this embodiment the system is a stand-alone system comprising of a client executed module (FIG. 1 500) and a server executed module containing a publicly accessible HTTP interface. In other embodiments the interface may support proprietary or standard public interfaces including but not limited to SOAP. The client and the server modules (FIG. 1 503) communicate over TCP/IP via a web server (FIG. 1 502). The client executed module provides in and outbound client communications between the client and the web—intranet server (FIG. 1 507) and can download the GUI components and form components or content that creates the active workspace instance. In this embodiment the client ‘talks’ to the server via a CGI script and uses Microsoft Internet Information Server as the web server. In other embodiments this communication can be achieved using proprietary methods. The web—intranet server passes the requests to the server module via HTTP on a specified port (FIG. 1 506). The server modules provide the storage (FIG. 1 508), and queues, directory, form creation and message parsing services. In other embodiments the server module supports protocols including but not limited to XML, SQL access, Java and COM. In this embodiment the TCP/IP client/server communications supports user event transfer from the client to the server allowing the executable content methods to be located and executed on either the client or the server.

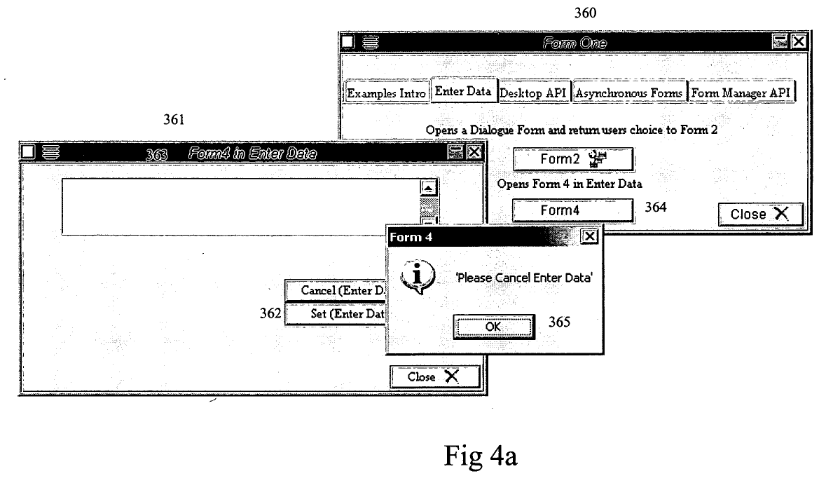

Workspace Configuration (FIG. 4)

The user workspace is configured at startup with parameters that define the number of workspace components the desktop properties, default frame services and behavior. In other embodiments this information may be supplied as a “System Header”.

Workspace Messages

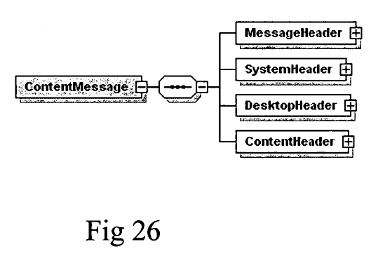

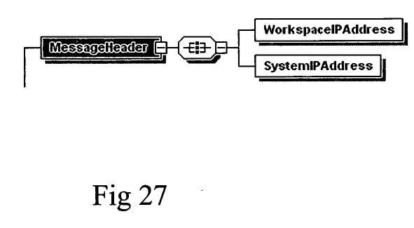

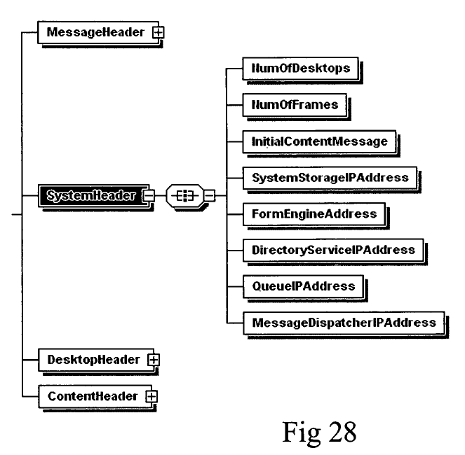

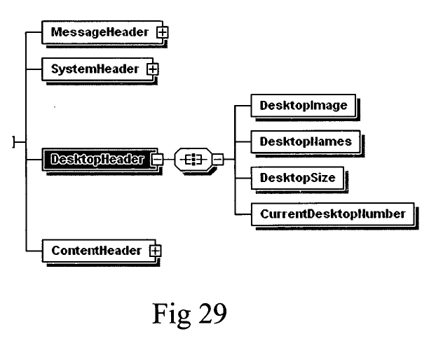

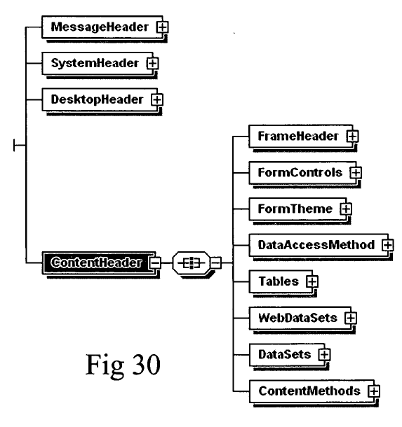

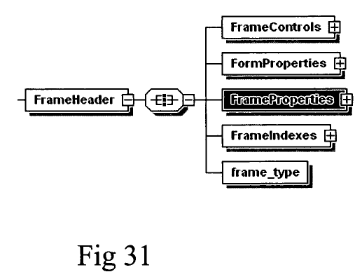

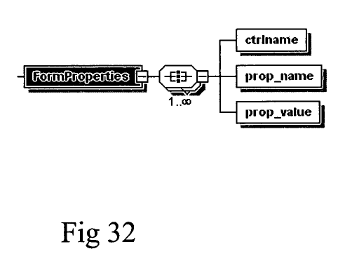

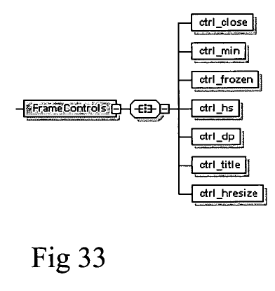

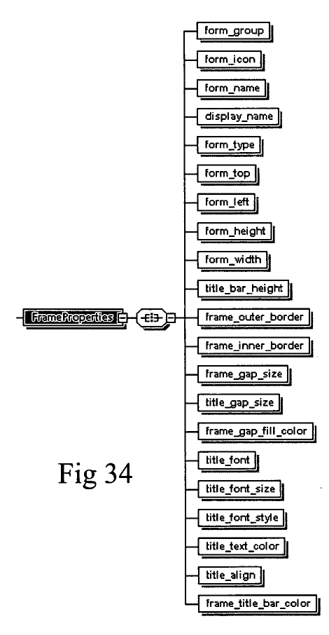

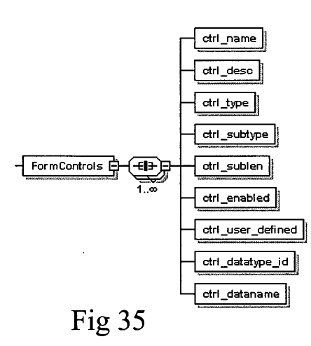

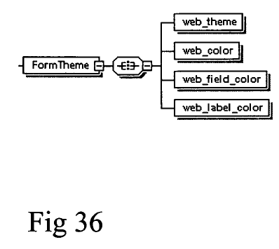

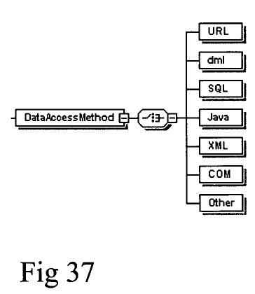

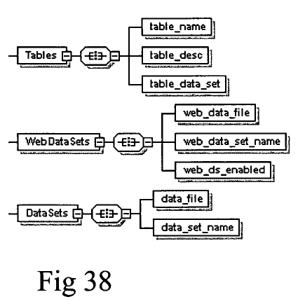

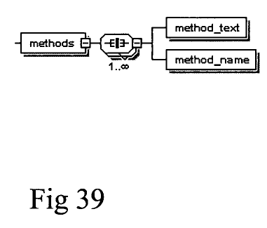

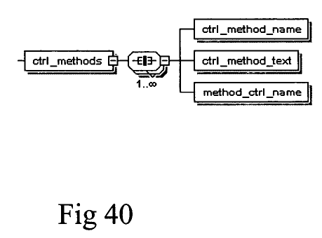

Messages from workflow processes are used to alter the workspace. In this embodiment the dynamic messages are implemented as one type of “content messages”. Content messages are used to specify as headers records—properties and behavior for the form based content and frames creation and at are used to dynamically configure and manage the framed content while it is in the user's workspace instance. The XML message in this embodiment uses a proprietary vocabulary, however, due to the open nature of XML, in other embodiments the message can be created using other vocabularies including but not limited to—XForms, XGUI. Below, the XML Content Message parts used to create and display and manipulate the content in a frame are described in detail.
Message Parts (FIG. 26): The content message is composed of complex types; The Message Header, System Header, Desktop Headers and the Content Header.
Message Header (FIG. 27): The message header defines the system address and the recipient workspace for the message.
System Header (FIG. 28): The system header contains pointers to the system components and system and workspace configuration information.
Desktop Header (FIG. 29): The desktop header contains information about the workspace desktop configuration.
Content Header (FIG. 30): The Content Header contains information relating to the content, frame, communication, behavior and look and feel of the both content and the frame the content is presented in and any storage requirements of the content. A content header may be sent repeatedly to the workspace to alter an existing properties and behavior of a frame and/or its content.
Frame Header (FIG. 31): The frame header provides information about the frame, its controls and properties, the form properties and content.
Form Properties (FIG. 32): Form Properties may be used to access any property of any component of the content. If specified at run time to an existing form the changes will be applied at run time to the form.
Frame Controls (FIG. 33): Frame controls that define the behavior of the frame may be set at run time.
Frame Properties (FIG. 34): Frame properties include categorization, opening position, dimensions, and display properties of the frame and may be set at run time using content messages.
Content Components (Form Controls) (FIG. 35): A wide range of pre-built or user designed controls form or component properties, methods and events may be specified in the Content Message to the form engine.
Form Themes (FIG. 36): A set of look and feel properties may be supplied to create a theme for the form and all its components.
Form Communications (FIG. 37): Proprietary communication modules are downloaded to the workspace at run-time. The server, however, offers in built communication services that are available to the forms. Through an external API custom client based or server communications services may be created.
Data Storage (FIG. 38): Data storage may be specified by the content message and provided by the system.
Form Methods (FIG. 39): Methods may be specified at the form class level rather than the component or control level. In this embodiment the executable method text is proprietary Omnis Studio programming language code but in other embodiments the code may be specified in, including but not limited to Java, JavaScript, ASP, JSP any XML language or scripting languages.
Form Control Methods (FIG. 40): Methods may also be specified for each form component.

One or more form components and specific component properties (beginning with ‘$’, property constants beginning with ‘k’) can be specified to the form engine when the form is created and dynamically changed by an XML document during the contents lifecycle in the workspace instance or while off-line, including:

Check Box
$text
The text or calculation stored with the object
Data Grid
$allowpictclipboard
kTrue if the datagrid picture allows clipboard support
$autosize
If true, the data grid sizes rows according to the contents
$boolascheck
kTrue if booleans are drawn as checkboxes
$booleanstrings
The strings to display for False and True Boolean values, False first, separated by a comma
$canresizecolumns
If true, the user can use the mouse to resize the columns of the object
$cellbordercolor
The color used to draw the grid cell borders
$columnactive
If kTrue the column is active
$columndatacol
The column number from which to map data
$columnenabled
If kTrue, the column is enabled
$columnforecolor
The foreground color of the column
$columnheadercolor
The color of the header
$columnheadertextcolor
The text color of the header
$columnjst
The alignment of the column
kLeftJst
kRightJst
kCenterJst
$columnnames
The names of the columns
$columnpicklist
The name of the picklist for the column
$columntextcolor
The text color of the column
$columntype
Specifies how data is handled for the column. One of the data grid type
constants
kDataGridAutoData
kDataGridComboPicker
kDataGridDroplistPicker
kDataGridIcon
$columnwidth
The width of the column in pixels
$currentcolumn
The current design column
$defaultheight
The default height of a grid cell
$defaultwidth
The default width of a column
$designcols
This is the number of design mode columns the control will show
$designrows
This is the number of design mode rows the grid will show
$displayformat
The format for the data displayed
kFormatNone
kFormatTime
kFormatShortDate
kFormatShortDateTime
kFormatLongDate
kFormatLongDateTime
$extendable
If true, the grid automatically extends to allow the user to enter more lines
$fixedcol
If true, the grid has a first fixed vertical column
$fixedrow
If true, the grid has a first fixed horizontal row
$gridcols
The datagrid/stringgrid column count
$gridendcolor
The color used to draw empty space after the end of the data
$gridrows
The datagrid/stringgrid row count
$listmode
kTrue if the datagrid is in list mode
$userdefined
If kTrue, the datagrid is developer defined and not automatic

Form File
$action
Defines the behaviour of the control
kFFRead
kFFReadNow
kFFWrite
kFFWriteNow
kFFReadEntireFile
kFFReadEntireFileNow
kFFWriteEntireFile
kFFWriteEntireFileNow
kFFSelectDir
kFFSelectDirNow
kFFReadDir
kFFReadDirNow
$buttonstyle
The drawing style of a button object: kNoBorderButton, kSystemButton, kHeadingButton, kComboButton, kRoundButton, or kUserButton kNoBorderButton
kSystemButton
kHeadingButton
kComboButton
kRoundButton
kUserButton
$filecreator
creator of the file to be written (Mac only)
$filename
default file name for the save file dialog
$filereadencoding
One of the kFFEncoding . . . constants. The value identifies how the data in the file to be read is encoded
kFFEncodingBinary
kFFEncodingNativeCharacters
kFFEncodingUTF8
kFFEncodingUTF16BE
kFFEncodingUTF16LE
kFFEncodingDetect
$filetype
type of the file to be written (Mac only)
$filewriteencoding
One of the kFFEncoding . . . constants (note that kFFEncodingDetect is not relevant when writing). The value identifies how the data is encoded when it is written to the file
kFFEncodingBinary
kFFEncodingNativeCharacters
kFFEncodingUTF8
kFFEncodingUTF16BE
kFFEncodingUTF16LE
$iconid
The numeric icon identifier used to reference the icon in the icon file
$text
The text or calculation stored with the object
$title
The window title
$typelist
comma seperated list of file types

Heading List
$::boldheader
If true, the heading of the heading list has a bold font
$::colcount
The number of columns for the list
$::columnnames
The names of the columns for a data grid or headed list box
$::columnwidths
Comma separated list of column widths, expressed in pixels
$::enableheader
If true, the user can click on the columns, generating an evHeaderClick event
$::hideheader
If true, the heading of the headed list box is hidden
$::multipleselect
If true, multiple lines can be selected
$aligncolumns
This string has a character for the alignment of each column (L=left, C=center, R=right); it does not apply to the column headings
$alignheadings
This string has a character for the alignment of each column heading (L=left, C=center, R=right)
$disableresizecolumns
If true, the user cannot use the mouse to resize the columns
$displayformat
The format for the data displayed
kFormatNone
kFormatTime
kFormatShortDate
kFormatShortDateTime
kFormatLongDate
kFormatLongDateTime

JPEG Viewer
$allowclipboard
If true, clipboard support is activated.
$fast
If kTrue, fast (less accurate) processing is required
$imageheight
Height of image
$imagewidth
Width of image
$keepaspectratio
If true, and $noscale is false, the aspect ratio of the picture is maintained when it is scaled
$noscale
If true, the picture field does not scale the picture
$nosmooth
If kTrue, smooth output is not required
$palette
Use the image palette
$picturealign
A kPAL . . . constant which, together with $horzscroll and $vertscroll, identifies where the picture will be positioned in the field
kPALtopLeft
kPALtopCenter
kPALtopRight
kPALcenterLeft
kPALcenter
kPALcenterRight
kPALbottomLeft
kPALbottomCenter
kPALbottomRight

QuickTime Movie Player
$action
Perform an action
kQTActionNone
kQTActionPlay
kQTActionStop
kQTActionPause
kQTAction Reverse
kQTActionStepFwd
kQTActionStepRev
kQTActionGotoFront
kQTActionGotoBack
$allowedit
If true, the movie can be edited
$audiolevel
The audio level of the current movie
$badge
If true, a badge will appear when the controller is hidden
$currenttime
The current time of the movie
$dragenabled
If true, the movie frame can be dragged out
$hastexttrack
If true, the movie has a text track
$keysenabled
If true, the keyboard keys are enabled for the movie
$loop
If true, the movie is to loop
$movieduration
The duration of the movie
$moviefile
Get/Set the movie filename
$movieloaded
If true, a movie is loaded
$movieurl
Get/Set the movie URL
$palindrome
If true, the movie is in palindrome mode
$playrate
The play back rate of the movie
$preferredplaybackrate
Use the preferred playback rate of the movie
$scaling
The current scaling which the movie uses
kQTScaleNone
kQTScaleNoAspectRatio
kQTScaleKeepAspectRatio
kQTScaleProportional
kQTScaleField
$selectiononly
Plays only the selected frames
$showcontroller
If true, the movie controller is shown
$showeveryframe
If true, every frame is played, and there is no sound
$showtexttrack
If true, the text track is shown
$suppresscontrols
Which controls are suppressed from the controller
$trackcount
The number of tracks in the movie

Picture Field
$allowclipboard
If true, clipboard support is activated
$cachepicture
If true, the object keeps a runtime copy of the native OS image corresponding to a shared picture. This results in faster drawing, at the cost of greater memory usage.
$keepaspectratio
If true, and $noscale is false, the aspect ratio of the picture is maintained when it is scaled
$noscale
If true, the picture field does not scale the picture
$picturealign
A kPAL . . . constant which, together with $horzscroll and $vertscroll, identifies where the picture will be positioned in the field
kPALtopLeft
kPALtopCenter
kPALtopRight
kPALcenterLeft
kPALcenter
kPALcenterRight
kPALbottomLeft
kPALbottomCenter

Push Button
$buttonstyle
The drawing style of a button object: kNoBorderButton, kSystemButton, kHeadingButton, kComboButton, kRoundButton, or kUserButton
kNoBorderButton
kSystemButton
kHeadingButton
kComboButton
kRoundButton
kUserButton
$iconid
The numeric icon identifier used to reference the icon in the icon file

Single Line Edit Field
$autotablen
The number of characters entered before automatically tabbing out of the field
$displayformat
The format for the data displayed
kFormatNone
kFormatTime
kFormatShortDate
kFormatShortDateTime
kFormatLongDate
kFormatLongDateTime
$negallowed
If true, the numeric entry field allows negative values
$passwordchar
If set, Omnis displays this character for each character entered, allowing private entry of passwords; if set, the data cannot exceed 255 characters. Using ‘*’ on Windows XP with themes enabled,displays a ‘blob’ character
$uppercase
If true, the entry field is upper case only

Tab bar
$::currenttab
The current tab number.
$::selectedtabcolor
The color of the current tab.
$::style
The style of the tabbar.
kDefaultWebTab
kSquareWebTab
kTriangleWebTab
$disabledcolor
The text color used when a tab is disabled.
$hilighttextcolor
The text color used when a tab is selected.
$nosoftab
The number tabs number present.
$position
The orientation of the tabbar on screen.
kDockingAreaTop
kDockingAreaBottom
kDockingAreaLeft
kDockingAreaRight
$tabtext
The text of a particular Tab.

Web Tree Control
$datamode
The mode for the list data specified via the data name; one of the kTreeData . . . constants
kTreeDataFlatList
kTreeDataFlatListWithTags
kTreeDataXMLPaths
kTreeDataXMLSaveTree
kTreeDataXMLIds
$defaultnodeicon
This is the tree default node icon
$expandcollapseicon
This is the tree expand collapse icon
$nodeiconspos
This is the position of the node icons
kIconOnLeft
kIconOnNode
kIconSystemSet
$showhorzlines
If true, the tree shows horizontal connecting lines
$shownodeicons
If true, the tree shows node icons
$showvertlines
If true, the tree shows vertical connecting lines
$treeindentlevel
This is the distance between tree levels
$treeleftmargin
This is the distance from the left the tree will leave before drawing
$treelinehtextra
This is extra spacing that can be applied to the tree lines
$treenodeiconmode
The node icons will change according to this state
kNodeIconFixed
kNodeIconLinkExpand
kNodeIconLinkLine

Button Area
noflash If true, the button area does not flash

Clock Component
$24hour
kTrue if the digital clock is shown in 24 mode
$::iconid
The icon id the clock will use to draw on the clock face
$digital
kTrue if the clock is digital
$digitalcolor
The color for the digital clock
kDigitalRed
kDigitalGreen
kDigitalBlue
$facecolor
The color of the clocks face
$hours
The current hours value
$hourscolor
The color of the hours hand
$iconface
kTrue if the clock draws an icon on the clock face.
$ispm
kTrue if the clock is in PM mode
$minutes
The current seconds value
$minutescolor
The color of the minutes hand
$pointscolor
The color of the clocks points
$scaleicon
kTrue if the clock scales the icon drawn on the clock face
$seconds
The current minutes value
$secondscolor
The color of the second hand
$showface
kTrue if the face is to be shown
$showhours
kTrue if the hour hand is to be shown
$showminutes
kTrue if the minute hand is to be shown
$showseconds
kTrue if the second hand is to be shown
$timezone
The clocks time zone
kGMTEniwetok
kGMTSamoa
kGMTHawaii
kGMTAlaska
kGMTPacificTime
kGMTMountainTime
kGMTCentralTime
kG MTEasternTime
kGMTAtlanticTime
kGMTBuenosAires
kGMTMidAtlantic
kGMTAzores
kGMTGreenwichMeanTime
kGMTBerlin
kGMTAthens
kGMTMoscow
kGMTAbuDhabi
kGMTIslambad
kGMTAlmaty
kGMTBangkok
kGMTHongKong
kGMTTokyo
kGMTBisbane
kGMTMagadan
kGMTFiji
$timezoneadj
kTrue if the clock adjusts by its time zone setting

Drop List
$listcolumn
The column of the list variable that is used to populate the drop down box
$listheight
The number of lines displayed in the list of the combo box or dropdown list

Form Port Control
$pbaudrate
The port baud rate
k110
k150
k300
k600
k1200
k1800
k2400
k3600
k7200
k9600
k14400
k19200
k38400
k57600
$pdatabits
The port data bits (7 or 8)
kPort7DataBits
kPort8DataBits
$pdatastream
If this property is false, then only bytesread will be returned if readstreaming is enabled
$phandshake
The port handshake (none, xon/xoff, hardware RTS/CTS)
kPortNoHandshake
kPortXonXoff
kPortHardware
$pinterruptkey
If this property is true, then IO for all ports will be stopped when the cancel key is pressed.
$pparity
The port parity (none, odd, even)
kPortNoParity
kPortOddParity
kPortEvenParity
$preadblocksize
The number of bytes to be read in a single read operation
$preadinterval
The number of seconds to wait before checking to see if data is available for reading
$preadstream
If this property is true, then an event will be sent to the server for each data block read
$pstopbits
The port stop bits (1 or 2)
kPort1StopBit
kPort2StopBits
$ptimeout
The number seconds before a read/write operation times out
$pwriteblocksize
The number of bytes to be written in a single write operation
$pwriteinterval
The number of seconds to wait before data is written
$pwritestream
If this property is true, then an event will be sent to the server for each data block written

Form Timer
$running
kTrue if the timer is running
$timervalue
The duration of the timer
$useseconds
If true, $timervalue is a value in seconds; otherwise it is a value in milliseconds

HOTPICT Control
$currentcursor
The cursor id for the current hot area
$currentid
The ID for the current hot area
$currentname
The name for the current hot area
$flashonclick
kTrue if the area inverts on click
$frameonenter
kTrue if the area hilites with a frame on enter
$invertonenter
kTrue if the area inverts on enter

List
$::boldheader
If true, the heading of the heading list has a bold font
$::colcount
The number of columns for the list
$::columnnames
The names of the columns for a data grid or headed list box
$::columnwidths
Comma separated list of column widths, expressed in pixels
$::enableheader
If true, the user can click on the columns, generating an evHeaderClick event
$::hideheader
If true, the heading of the headed list box is hidden
$::multipleselect
If true, multiple lines can be selected
$aligncolumns
This string has a character for the alignment of each column (L=left, C=center, R=right); it does not apply to the column headings
$alignheadings
This string has a character for the alignment of each column heading (L=left, C=center, R=right)
$disableresizecolumns
If true, the user cannot use the mouse to resize the columns
$displayformat
The format for the data displayed
kFormatNone
kFormatTime
kFormatShortDate
kFormatShortDateTime
kFormatLongDate
kFormatLongDateTime

Multi Line Edit
$negallowed
If true, the numeric entry field allows negative values
$uppercase
If true, the entry field is upper case only

Printing Control
$nojobsetup
if true, the job setup dialog is suppressed when printing to printer
$reporttitle
the title given to the report when sent to the printer
$showhscroll
if true, horizontal scrollbar is shown when required
$showstatusbar
if true, statusbar is visible
$showtoolbar
if true, toolbar is visible
$showvscroll
if true, vertical scrollbar is shown when required
$strbutt1
resource for ‘Print’
$strbutt2
resource for ‘Print Page’
$strbutt3
resource for ‘Preview’
$strbutt4
resource for ‘Normal’
$strbutt5
resource for ‘Zoom’
$strjobdlg1
resource for ‘All’
$strjobdlg10
resource for ‘Other Pages:’
$strjobdlg11
resource for ‘Copies’
$strjobdlg12
resource for ‘Page Range’
$strjobdlg 13
resource for ‘Number of Copies:’
$strjobdlg2
resource for ‘Range:’
$strjobdlg3
resource for ‘Pages:’
$strjobdlg4
resource for ‘Enter page numbers/ranges separated by commas. Example 1-3, 5, o10-20, e10-20’
$strjobdlg5
resource for ‘Default Tray’
$strjobdlg6
resource for ‘OK’
$strjobdlg7
resource for ‘Cancel’
$strjobdlg8
resource for ‘&Properties . . . ’
$strjobdlg9
resource for ‘First Page:’
$strjobdlgtitle
resource for ‘Job Setup’
$strstatus
resource for ‘Page $ of $’
$zoomon
if true, preview is in 100% view

Radio Group
$columncount
The number of columns shown for the radio group
$horizontal
If true, the radio column order is horizontal
$maxvalue
The maximum value for the radio group
$minvalue
The minimum value for the radio group

Slider
$::max
The maximum value for the slider
$::min
The minimum value for the slider
$bigrange
kTrue if the slider range is drawn larger
$block
kTrue if the slider part is a block
$blockcolor
The color of the slider
$facecolor
The color of the slider face
$horzmargin
The horizontal drawing margin
$markcolor
The color of the slider marks
$markfreq
The number of points between range values. 1=all marks
$rangecolor
The color of the slider range
$selend
The selection end value
$selrangecolor
The color of the slider selected range
$selstart
The selection start value
$showmarks
kTrue if the slider shows marks
$val
The current value of the slider
$vertical
kTrue if the slider is a vertical slider
$vertmargin
The vertical drawing margin

Trans button
$::effect
The 3D effect for a field object.
kBorderNone
kBorderPlain
kBorderInset
kBorderEmbossed
kBorderBevel
kBorderInsetBevel
kBorderChisel
kBorderEmbossedChisel
kBorderShadow
kBorderSingleInset
kBorderSingleEmbossed
kBorder3DFace
kBorder3DHilite
kBorderCtrlEdit
kBorderCtrlList
kBorderCtrlListCell
kBorderCtrlTabPane
kBorderCtrlShadow
kBorderCtrlShadowEx
kBorderCtrlGroupBox
$alwayactive
kTrue if the control bitmap is drawn as active
$boldover
kTrue if the font is always bold if the mouse is over the control
$centericon
If true then the icon will be displayed in the center of the control
$insideicon
The icon id for the control while the mouse is inside the control
$nograyeffect
kTrue if the control does not gray effect the image when disabled
$outsideicon
The icon id for the control while the mouse is outside the control
$text
The text or calculation stored with the object

Calendar Control
$allowchange
kTrue if the user can change the current date
$currday
The calendar's current date as a string.
$currdaycolor
The color of the current day
$currdaymode
The drawing style for the current day
kBorderNone
kBorderPlain
kBorderInset
kBorderEmbossed
kBorderBevel
kBorderInsetBevel
kBorderChisel
kBorderEmbossedChisel
kBorderShadow
kBorderSingleInset
kBorderSingleEmbossed
kBorder3DFace
kBorder3DHilite
kBorderCtrlEdit
kBorderCtrlList
kBorderCtrlListCell
kBorderCtrlTabPane
kBorderCtrlShadow
kBorderCtrlShadowEx
kBorderCtrlGroupBox
$currdaytextcolor
The color of the current date
$daycolor
The color of the other days in this month
$dayfont
The font used for the days
$dayfontsize
The font size used for the days
$daymode
The drawing style for the days in this month
kBorderNone
kBorderPlain
kBorderInset
kBorderEmbossed
kBorderBevel
kBorderInsetBevel
kBorderChisel
kBorderEmbossedChisel
kBorderShadow
kBorderSingleInset
kBorderSingleEmbossed
kBorder3DFace
kBorder3DHilite
kBorderCtrlEdit
kBorderCtrlList
kBorderCtrlListCell
kBorderCtrlTabPane
kBorderCtrlShadow
kBorderCtrlShadowEx
kBorderCtrlGroupBox
$firstday
The first day the calendar will show
kSunday
kMonday
kTuesday
kWednesday
kThursday
kFriday
kSaturday
$headingbold
kTrue if the heading should be drawn in bold
$headingcolor
The color used for the heading
$headingfont
The font used for the heading section
$headingfontsize
The font size used for the heading section
$headingmode
The drawing style for the heading
kBorderNone
kBorderPlain
kBorderInset
kBorderEmbossed
kBorderBevel
kBorderInsetBevel
kBorderChisel
kBorderEmbossedChisel
kBorderShadow
kBorderSingleInset
kBorderSingleEmbossed
kBorder3DFace
kBorder3DHilite
kBorderCtrlEdit
kBorderCtrlList
kBorderCtrlListCell
kBorderCtrlTabPane
kBorderCtrlShadow
kBorderCtrlShadowEx
kBorderCtrlGroupBox
$headingtextcolor
The color of the text in the heading
$monthtextcolor
The color of the days in this month
$otherdaycolor
The color of days not in this month
$otherdaymode
The drawing style for the previous and next months days
kBorderNone
kBorderPlain
kBorderlnset
kBorderEmbossed
kBorderBevel
kBorderlnsetBevel
kBorderChisel
kBorderEmbossedChisel
kBorderShadow
kBorderSinglelnset
kBorderSingleEmbossed
kBorder3DFace
kBorder3DHilite
kBorderCtrl Ed it
kBorderCtrlList
kBorderCtrlListCell
kBorderCtrlTabPane
kBorderCtrlShadow
kBorderCtrlShadowEx
kBorderCtrlGroupBox
$othertextcolor
The color of the days in previous and next month
$shortname
kTrue if the days should be drawn using a short name
$showheading
kTrue if the days of the week should be shown
$todaybold
kTrue if todays date should be drawn in bold
$todayscolor
The color of today
$todaystextcolor
The color of todays date

Combo Box
$::listname
The name of the list to display combo choices
$listcolumn
The column of the list variable that is used to populate the drop down box
$listheight
The number of lines displayed in the list of the combo box or dropdown list
$uppercase
If true, the entry field is upper case only

Fade Pict Control
$borderh
A horizontal border that can be applied when the image is stretched
$borderv
A vertical border that can be applied when the image is stretched
$designfade
The color used when showing a sample fade in design mode
$disolvesize
The size of the area used during the dissolve fade.
$fadeondatachange
kTrue if the image fades when the control's data is changed
$fadestyle
The type of fade used as a transition between images
kFadeBlindDown
kFadeBlindUp
kFadeBlindLeft
kFadeBlindRight
kFadeSlideDown
kFadeSlideUp
kFadeSlideLeft
kFadeSlideRight
kFadeCircleIn
kFadeCircleOut
kFadeBoxIn
kFadeBoxOut
kFadeHorizontalSlideIn
kFadeVerticalSlideIn
kFadeHorizontalSplitIn
kFadeHorizontalSplitOut
kFadeVerticalSplitIn
kFadeVerticalSplitOut
kFadeQuartersIn
kFadeQuartersOut
kFadeStretchCenterIn
kFadeStretchCenterOut
kFadeStretchHalf
kFadeStretchQuarter
kFadeDisolve
kFadeDisolveToFill
kFadeWashDown
kFadeWashUp
kFadeWashLeft
kFadeWashRight
kFadeSpiralIn
kFadeSpiralOut
kFadeSqueezeHorizontal
kFadeSqueezeVertical
kFadeBounce
$fillcolor
The color for the background of the control
$stretch
kTrue if the control stretches the image to fit the control bounds
$timerinterval
The number of ticks between frames

Form Roll Component
$::backcolor
Color of the background
$betweenlines
Distance between text lines
$faded
kTrue if the button is faded
$insideimage
The image used when the mouse is in the object
$insidestyle
Text style used when the mouse is in the object
$insidetext
The text that needs to be displayed when the mouse is outside the object
$outsideimage
The image used when the mouse is not in the object
$outsidestyle
Text style used when the mouse is not in the object
$outsidetext
The text that needs to be displayed when the mouse is outside the object
$textx
Left position of the text to be drawn
$texty
Top position of the text to be drawn

GIF viewer
$action
Defines the behaviour of the control
kFFRead
kFFReadNow
kFFWrite
kFFWriteNow
kFFReadEntireFile
kFFReadEntireFileNow
kFFWriteEntireFile
kFFWriteEntireFileNow
kFFSelectDir
kFFSelectDirNow
kFFReadDir
kFFReadDirNow
$buttonstyle
The drawing style of a button object: kNoBorderButton, kSystemButton, kHeadingButton, kComboButton, kRoundButton, or kUserButton
kNoBorderButton
kSystemButton
kHeadingButton
kComboButton
kRoundButton
kUserButton
$filecreator
creator of the file to be written (Mac only)
$filename
default file name for the save file dialog
$filereadencoding
One of the kFFEncoding . . . constants. The value identifies how the data in the file to be read is encoded
kFFEncodingBinary
kFFEncodingNativeCharacters
kFFEncodingUTF8
kFFEncodingUTF16BE
kFFEncodingUTF16LE
kFFEncodingDetect
$filetype
type of the file to be written (Mac only)
$filewriteencoding
One of the kFFEncoding . . . constants (note that kFFEncodingDetect is not relevant when writing). The value identifies how the data is encoded when it is written to the file
kFFEncodingBinary
kFFEncodingNativeCharacters
kFFEncodingUTF8
kFFEncodingUTF16BE
kFFEncodingUTF16LE
$iconid
The numeric icon identifier used to reference the icon in the icon file
$text
The text or calculation stored with the object
$title
The window title
$typelist
comma seperated list of file types

Icon Array
$autoarrange
If true, the icon array recalculates the number of columns when its size changes
$buttonbackground
If true, the icons are drawn on a button face background
$multipleselect
If true, the field allows the user to select more than one line
$showtext
If true, the toolbar buttons or icon array also display text
$smallicons
If true, the icon array displays small icons

Marquee Control
$::backcolor
The background color of the message
$::font
The font name for the message
$::fontsize
The font size for the message
$::textcolor
The color of the message
$message
The scrolling message
$speed
The scrolling speed for the marquee message

Paged Pane
$::boldheader
If true, the heading of the heading list has a bold font
$::colcount
The number of columns for the list
$::columnnames
The names of the columns for a data grid or headed list box
$::columnwidths
Comma separated list of column widths, expressed in pixels
$::enableheader
If true, the user can click on the columns, generating an evHeaderClick event
$::hideheader
If true, the heading of the headed list box is hidden
$::multipleselect
If true, multiple lines can be selected
$aligncolumns
This string has a character for the alignment of each column (L=Ieft, C=center, R=right); it does not apply to the column headings
$alignheadings
This string has a character for the alignment of each column heading (L=left, C=center, R=right)
$disableresizecolumns
If true, the user cannot use the mouse to resize the columns
$displayformat
The format for the data displayed
kFormatNone
kFormatTime
kFormatShortDate
kFormatShortDateTime
kFormatLongDate
kFormatLongDateTime

Progress Bar
$::backcolor
The color of the background of the progress bar
$::max
The maximum value for the progress range
$::min
The minimum value for the progress range
$blocks
If true, the progress bar is drawn in blocks. If true, and $disableostheme is false, the bar is drawn using the operating system theme (ignoring $progresscolor), on Mac OSX and Windows XP with themes enabled
$disableostheme
If true, and $blocks is also true, the control will not use the operating system progress bar theme
$progresscolor
The color of the progress bar
$val
The current value in the progress range (between $min and $max)

Sidebar
$buttonfillcolor
The color used to fill the selection button
$currenticon
The current icon selected in the set of icons
$currentset
The current set of icons
$fillcolor
The color with which the side bar control will its background area
$flipswitch
kTrue if the control does not slide in the new range of icons
$groupbackcolor
The backcolor for group buttons
$groupfont
The font used to draw the group buttons
$groupfontsize
The font size for $groupfont
$groupselectedbackcolor
The selected backcolor for group buttons
$groupselectedtextcolor
The selected text color for group buttons
$groupselectedtextstyle
The selected text style for group buttons
$grouptextcolor
The text color for group buttons
$grouptextstyle
The text style for group buttons
$labelcolor
The text color of the icon labels
$labelfont
The font used to draw the labels
$labelfontsize
The font size for $labelfont
$labelpos
The position the label draws within the sidebar
kSidebarLabel Bottom
kSidebarLabelTop
kSidebarLabelLeft
kSidebarLabelRight
$labelstyle
The text style of the icon labels
$selectcurrent
kTrue if the current icon is drawn in a hilited state
$selectedlabelcolor
The text color of the current icon's label
$selectedlabelstyle
The text style of the current icon's label
$show3dundermouse
kTrue if a 3D rectangle is shown on the current item
$showiconnames
kTrue if the icon names are drawn
$tilebmp
The icon to use when tiling the background
$tilestrip
kTrue if the background is tiled.
$washdirection
The wash direction
kSidebarWASHdown
kSidebarWashup
kSidebarWashleft
kSidebarWashright
$washendcolor
Ending color for color wash
$washstartcolor
Starting color for color wash
$washstrip
kTrue if the background is washed

Sub Form Field
$classname
The class name for the subwindow
$multipleclasses
If true, multiple classes can be open at runtime
$nobackground
If true, the subwindow has no background
$parameters
The constructor parameters for the subwindow

User Info Control
$userdata
User specified data which will be provided during evUserDatalnit event
$userkey
User key under which the userdata is stored. userkey is a global reference therefore must be unique between libraries.
   System Process (FIG. 1a)

The message dispatcher (FIG. 1a 601) takes content display messages from remote processes via the public interface and parses the content message for message parameters. If the content message specifies a new form, the frame content header, which in another embodiment may be expressed as a valid XForm document XForms Model and the XForms User Interface, is passed (FIG. 1a 604) to the form engine who creates the specified form (FIG. 1a 602). The message header (FIG. 1a 610) is passed to the directory service (FIG. 1a 603) which locates the user's asynchronous queue (FIG. 1a 611) and the content message frame header is placed the users queue. The user's workspace collects the frame header (FIG. 1a 605), parses it for the frame service requirements and any behavior or property modifications to be applied to the frame (FIG. 1a 606,607). The workspace applies the changes (FIG. 1a 608) and passes the frame the locator for the content. The frame then downloads the frame content from the server (FIG. 1a 609) to the client where the component containing any content specific communications remains and can be updated should the specific component version change.

Form Engine

The form engine receives the frame or content header record and will assemble the specified form and form components—(content)—and apply the component properties and create the component methods with the specified events. Once created the form is stored on disk until the workspace requests it.

Methods

In this embodiment the form and/or form component methods are specified in the native programming language of Omnis Studio, however, other embodiments will support any programming language.

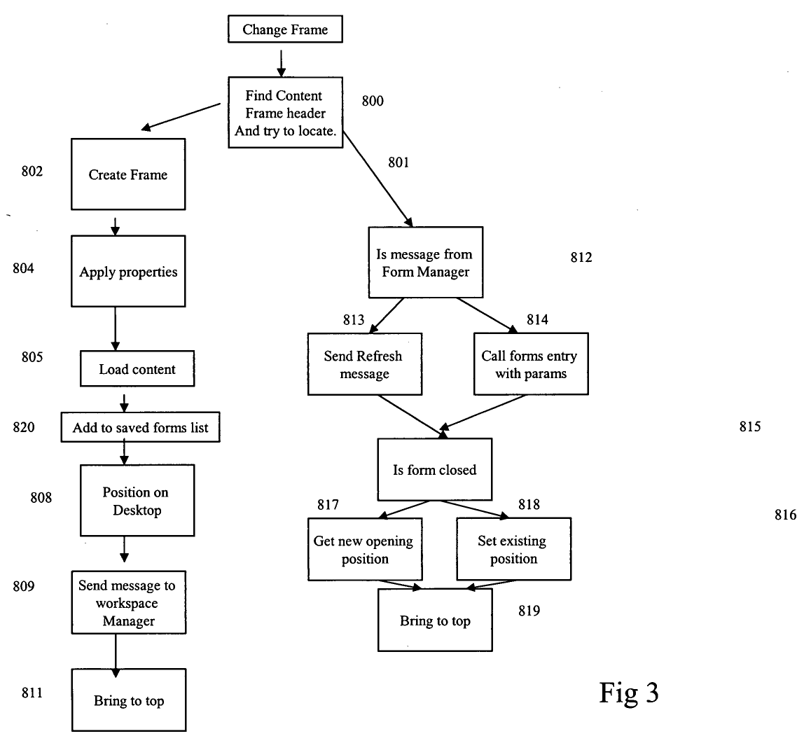

Process Modifying the Workspace (FIG. 3)

While the workspace instance is alive content messages may be delivered to the queue for content that is already in the user's workspace. The system will bypass the form engine (FIG. 1a 610) and once the workspace/user is located (FIG. 1a 603) pass the frame header to the workspace. The workspace will identify the frame by parameters in the frame header message and apply the new header properties and behavior to the existing frame and content (FIG. 1a 606). In this way, it is able to interact concurrently with the user interaction in the workspace via the workflow processes manipulating any property or behavior of the workspace, desktop frame or content.

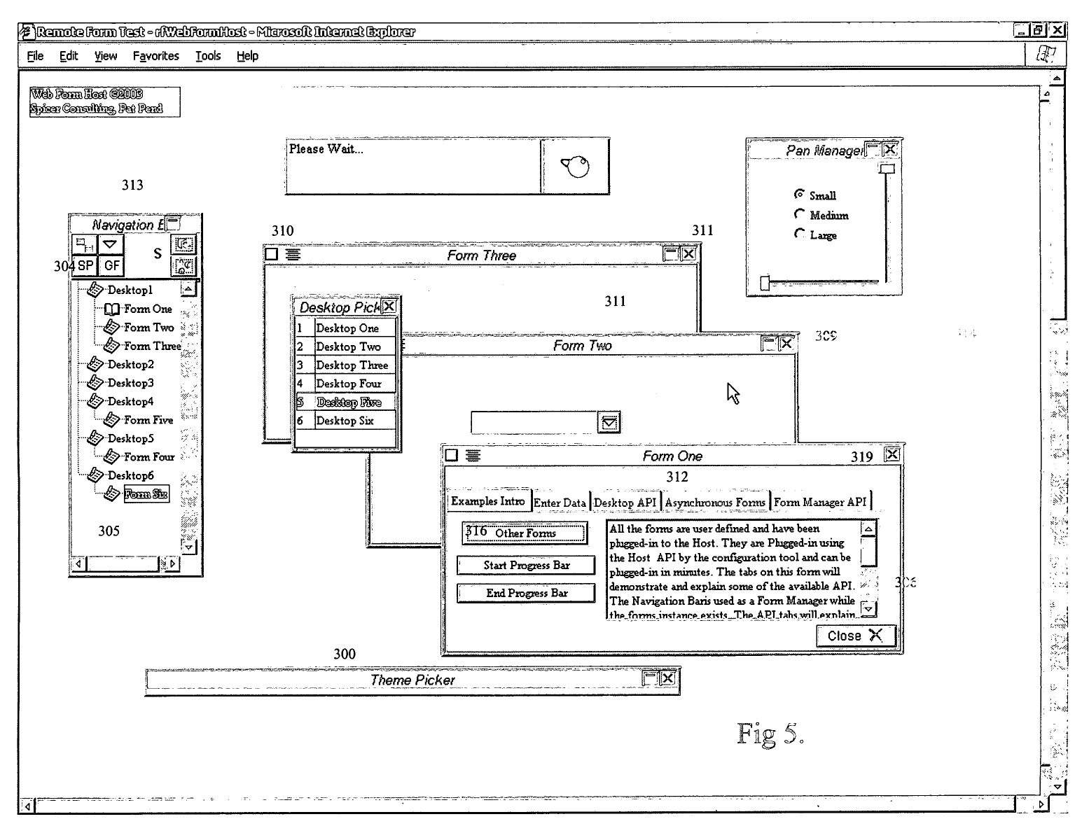

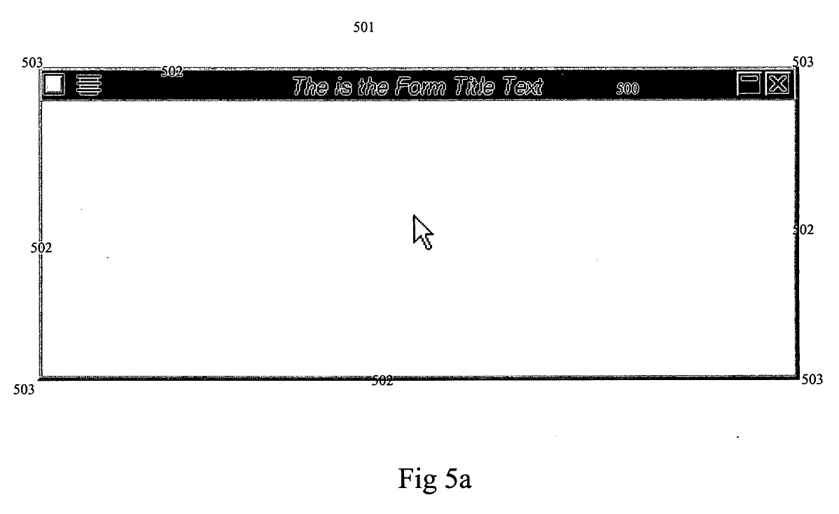

User Modifying the Workspace (FIG. 5)

While the workspace instance is alive the user may interact with the GUI workspace. In this embodiment the workspace notifies a specified frame of all changes to the workspace called the workspace manager (FIG. 5 313). The workspace manager displays the current workspace contents and also allow the user to create frame header information on the client and submit it to the system locally on the client (FIG. 1a 608). This allows the user the same control over the workspace dynamics as the content messages delivered to the system by a remote process. It can be used to present the information relating to current workspace activities, prior workspace definitions and content, perpetually available content as in standard document types and services. In this embodiment these are displayed in a tree list. In other embodiments these may be displayed using graphical icons.

Desktop Properties and Behavior

In FIG. 5 the graphical desktop is multi-layered (FIG. 5a) and provides methods that allow the run-time manipulation of properties and behavior not limited to: the desktop size, desktop scrolling, the visible order of the stacked desktops, the desktop background image, all of which may be specified at run-time and are described in detail below.

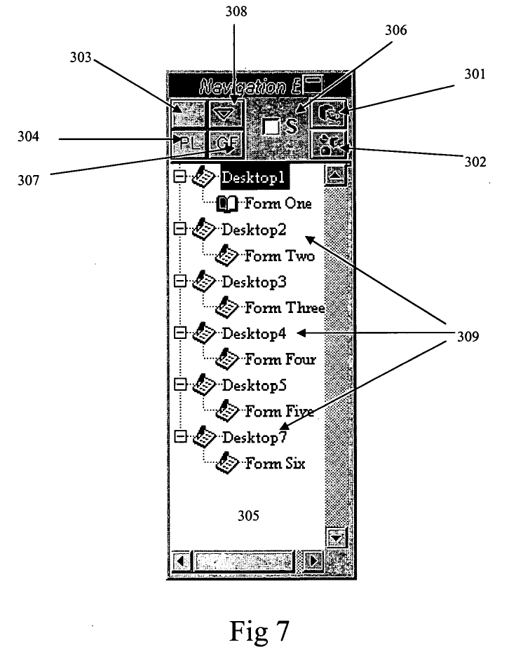

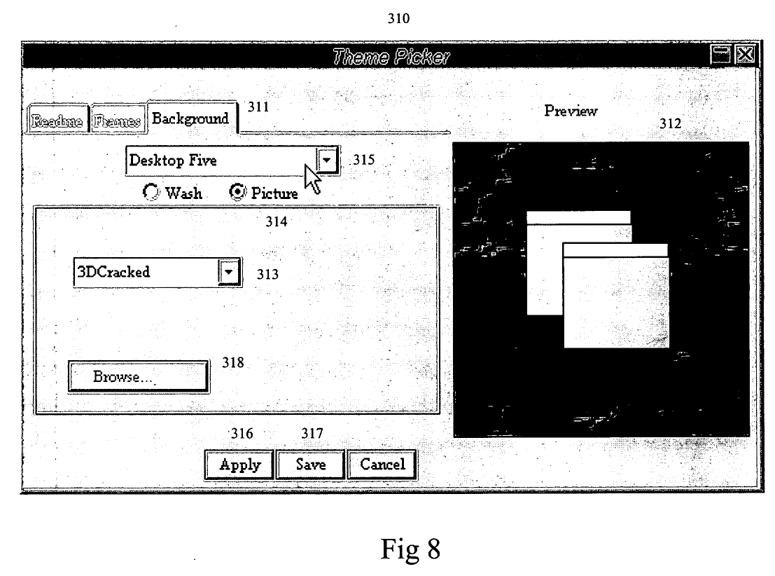

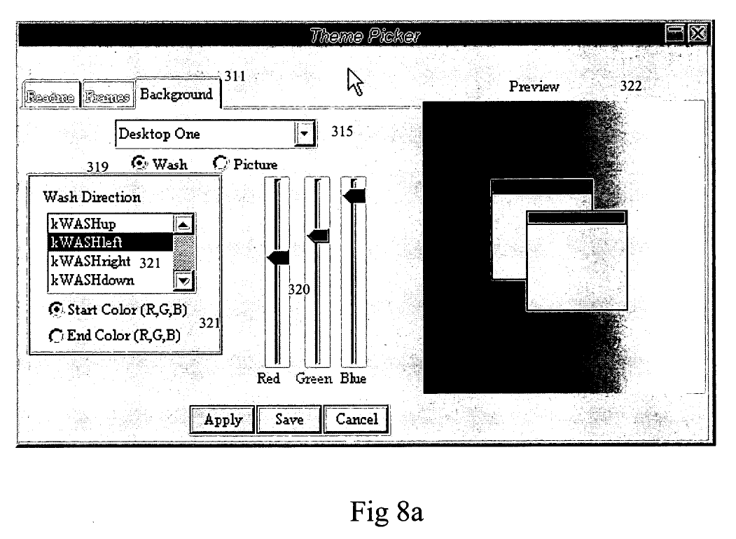

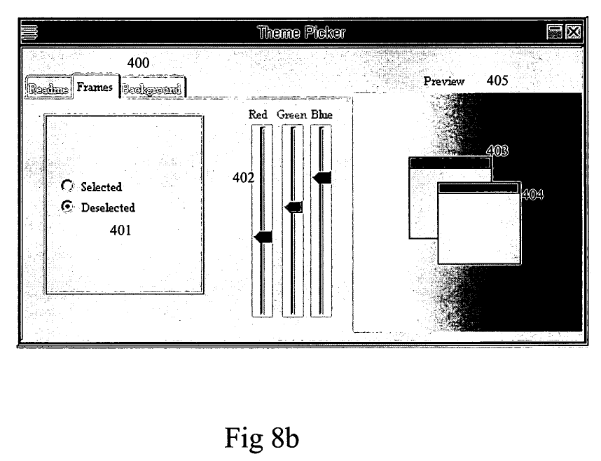

In FIG. 5 the background image may be set (FIG. 5 314). In this embodiment this is demonstrated by the user setting the desktop image using the Theme Manager (FIG. 8). The user may access the Theme manager (FIG. 8) from the Form Manager (FIG. 7 301) control. The user may select a tab in The Theme Manager (FIG. 8) allowing the user to specify theme properties to the environment. The user may change the background by selecting the second Tab ‘Background’ (FIG. 8 311) and by selecting an image name from the list of images (FIG. 8 313) to be displayed from a drop down list of images. The image is previewed for the user in the preview pane (FIG. 8 312). The user may apply the background previewed in the preview pane by selecting the Apply button (FIG. 8 316) which will use methods to set the background properties to the selected desktop. The user may then save then Save (FIG. 8 316) the applied theme so that whenever the workspace is opened the saved theme is used. In other embodiments any image type may be used including but not limited to—Static image formats i.e. JPEG, moving image formats i.e. GIF or streaming image files.

In FIG. 8a the user may specify a wash image to the desktop by selecting the Wash radio button (FIG. 8a 319). The wash direction (FIG. 8a 321) may be set and the start and end color of the wash (FIG. 8a 321) may be set using the color sliders (FIG. 8a 320). Again, the selected wash background is previewed and the user may apply and save the background.

In FIG. 8b the user may set the selected and deselected colors of the frame title bars (FIG. 8b 403,404). By selecting the Frames tab (FIG. 8b 400) the user may select, the using the radio buttons (FIG. 8b 401), the frame that they wish to set the color of. They may use the colors sliders (FIG. 8b 402) to select a frame title color and the selected title bar color will be previewed in the preview pane (FIG. 8b 405). The selections are previewed in the preview pane and may be saved after being previewed.

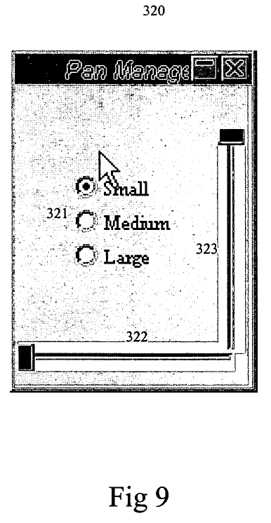

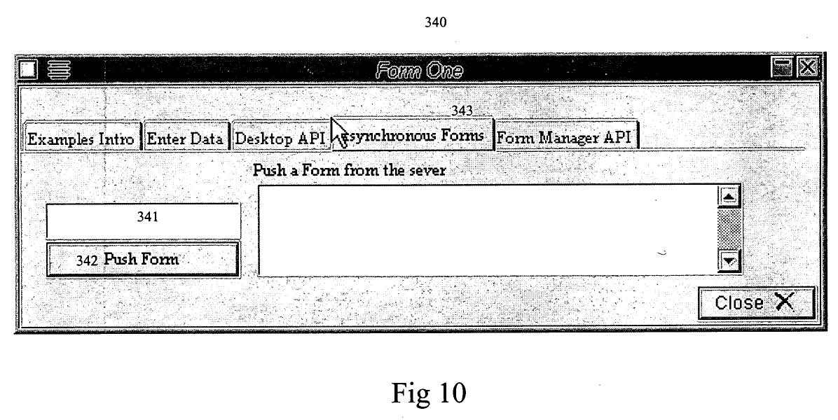

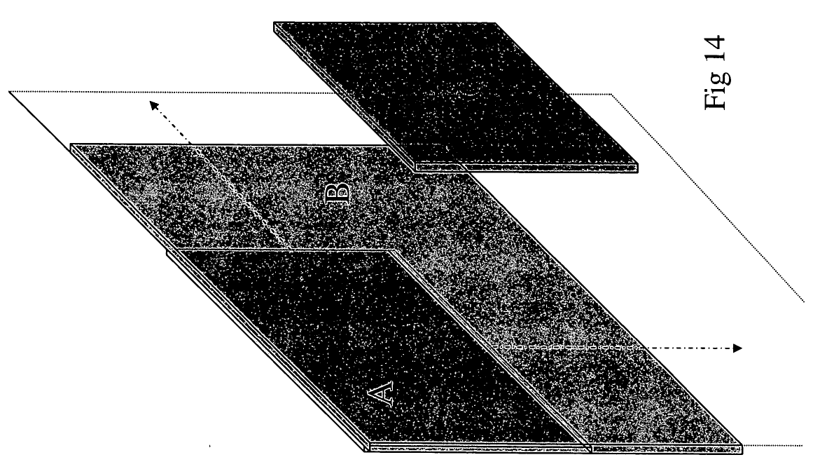

In FIG. 14 the desktop may be scrolled. In this embodiment this is demonstrated by using graphical Sliders (FIG. 9 322,323) contained in the Pan Manager form (FIG. 9). A user may click on the Slider (FIG. 9 323) that is used to generate the scrolling events—and by holding the right button mouse down can drag the Slider (FIG. 9 322) left or right or up and down (FIG. 9 323). The current desktop (FIG. 14 A) will scroll according to the sliders (FIG. 9 322, 323) motion causing the visible desktop space under the browser window (FIG. 14 B) to change. In other embodiments other types of controls may be used to provide multidirectional panning.

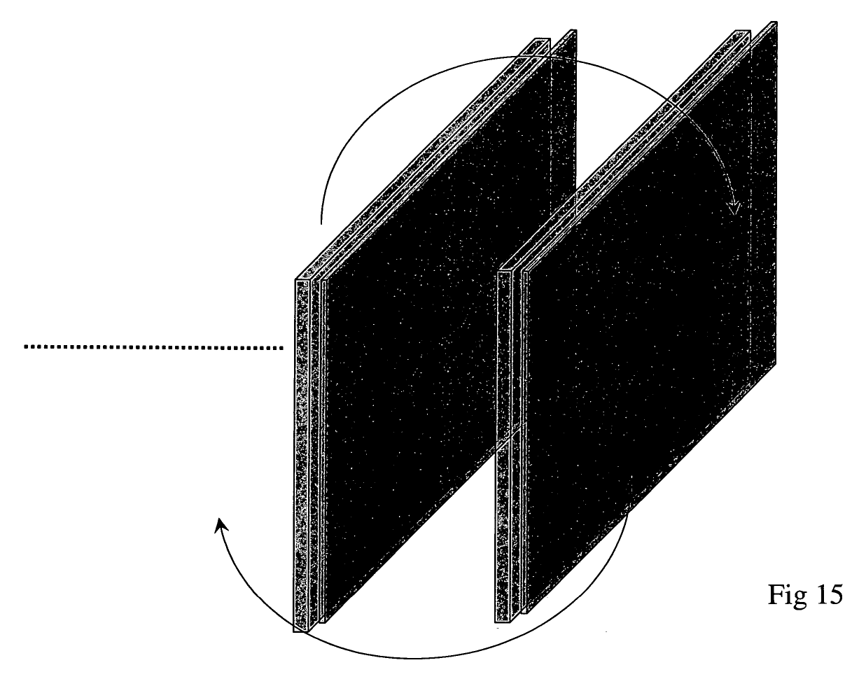

In FIG. 15 the desktop size may be changed. It may be expanded from being the same size (FIG. 15 A) or smaller than the area exposed by the browser window (FIG. 15 C). In this embodiment this is demonstrated by the user using the radio buttons (FIG. 9 321) contained in the Pan Manager (FIG. 9). A user can click on the preferred desktop size (FIG. 9 321) using the mouse and the current desktop will expand or contract to the size specified (FIG. 9 321). This may be much larger or smaller than the desktop area visible through browser window (FIG. 15 B). In other embodiments the desktops may be tiled allowing multiple tiled layered desktops.

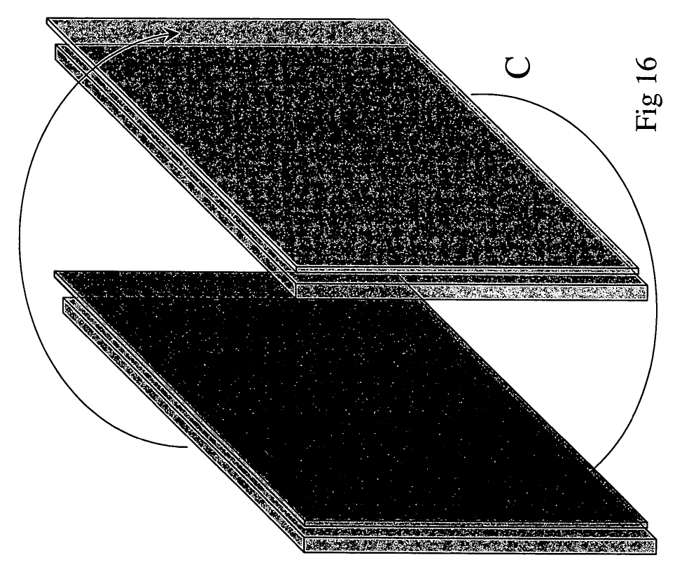

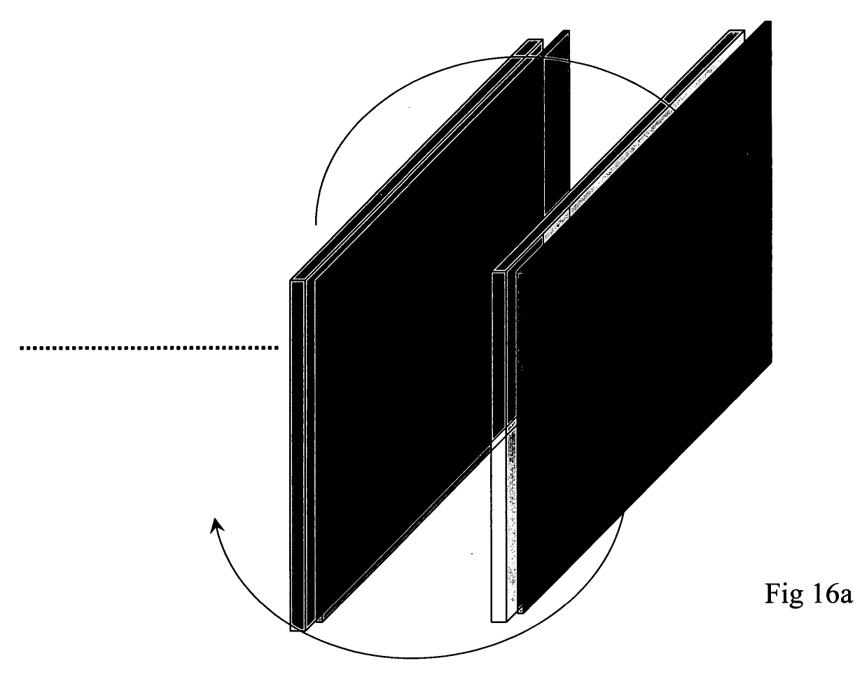

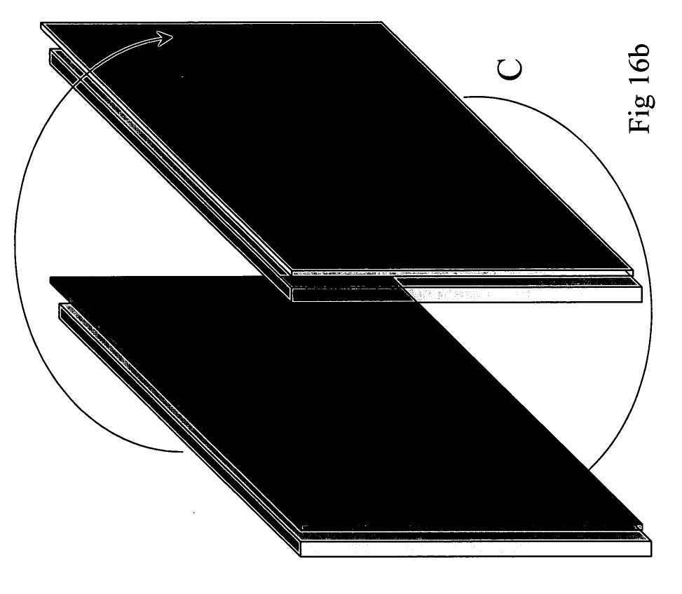

In FIG. 16 the visible desktop i.e. the current visible desktop may be changed. In this embodiment this is demonstrated by the user providing the required data, the desktop name, by selecting a tree list node from the tree list (FIG. 7 309) contained in the Navigation Bar (FIG. 7). The user may click on a desktop node (FIG. 7 309) within the tree list (FIG. 7 305). This event will switch the current desktop to the selected desktop number or name represented by the node text or icon as in (FIG. 7 305). In other embodiments the desktops may individually be made visible or invisible.

Content to Server Messaging Support

In this embodiment of the invention the frame can contain a wide range of content. The frame content has the required specialist communication services pre-built into the component. (FIG. 1a 602) including but not limited to standard HTML, XML, QuickTime. All components that make up the content have component specific events which may be specified as executing locally or on the server so that the methods are executed locally or on the server. (FIG. 5). External API's are available to create non-standard support for a wide range of other graphical user interface components and specific communications.

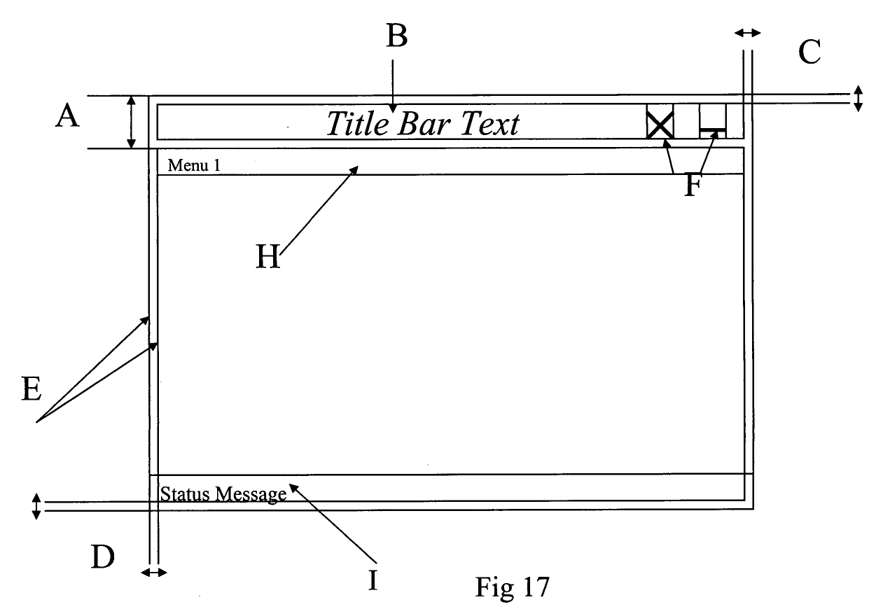

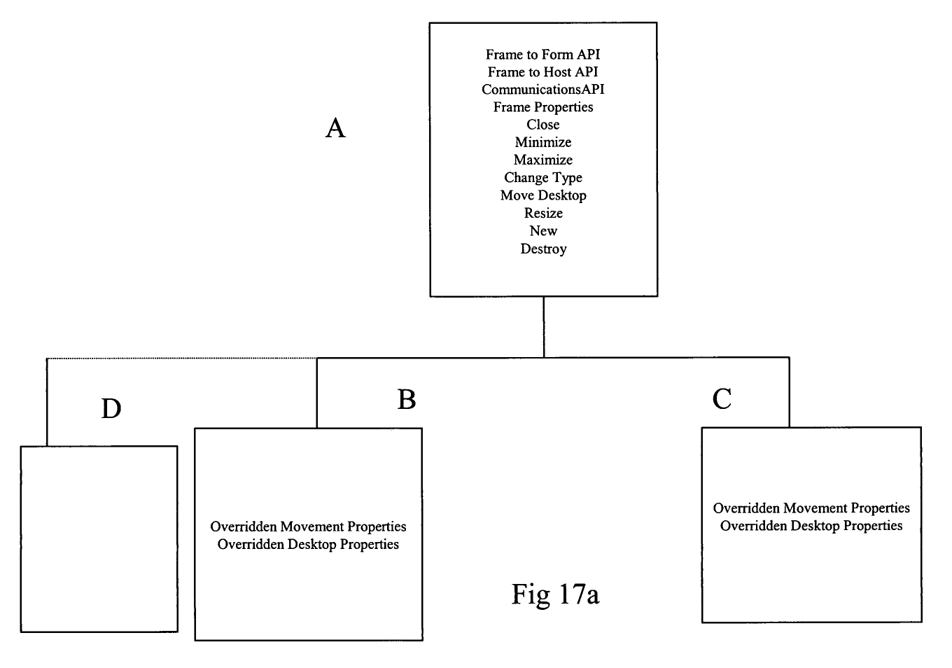

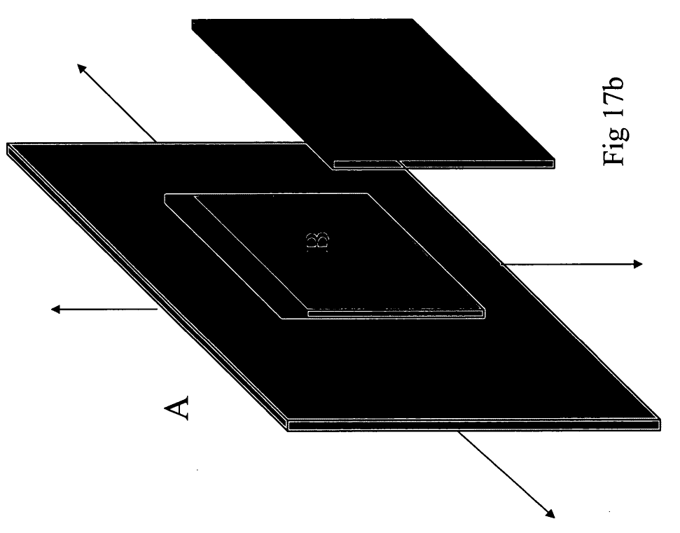

Frame Properties and Behavior (FIG. 17)

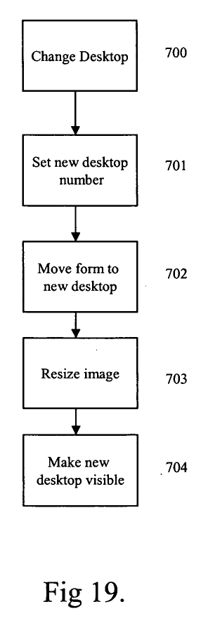

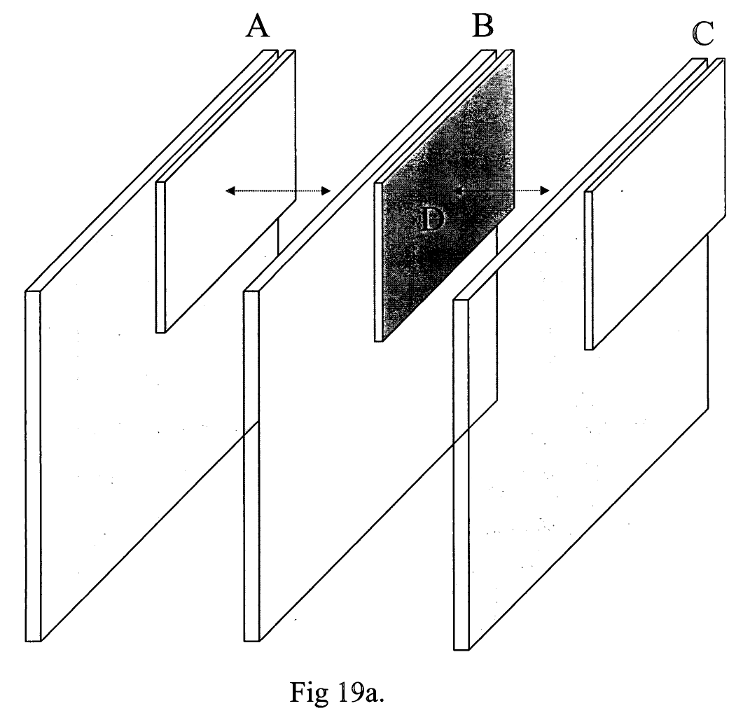

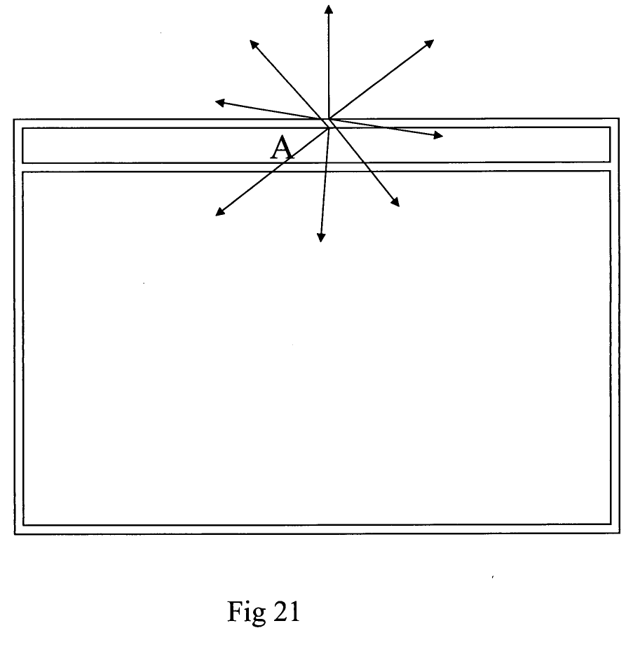

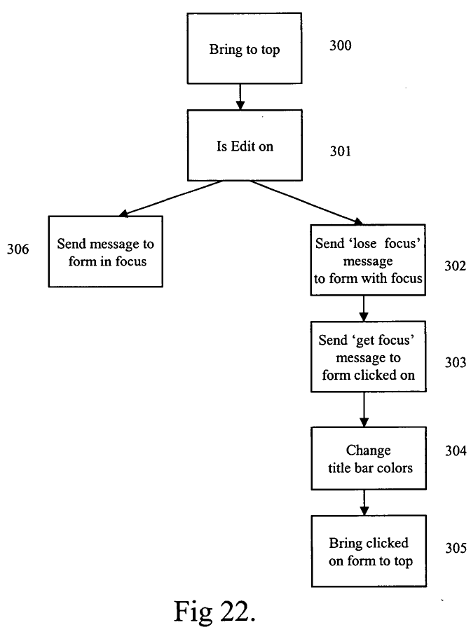

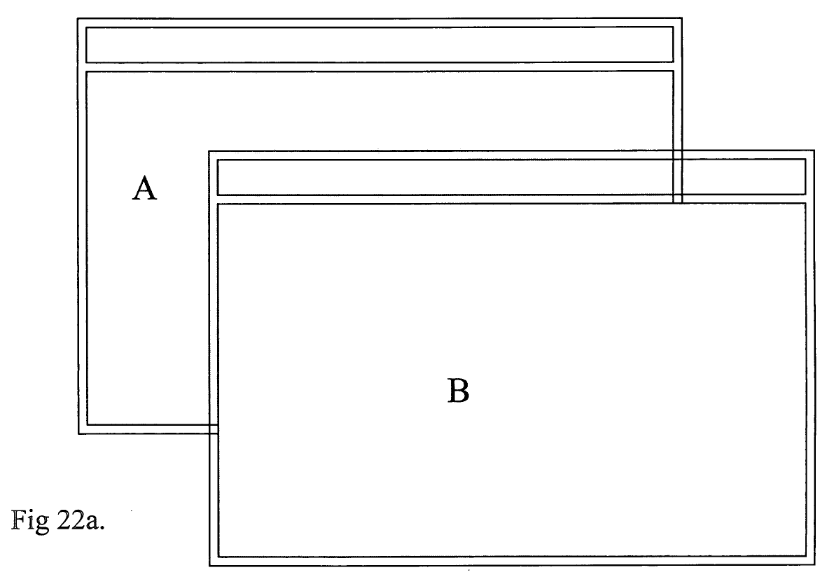

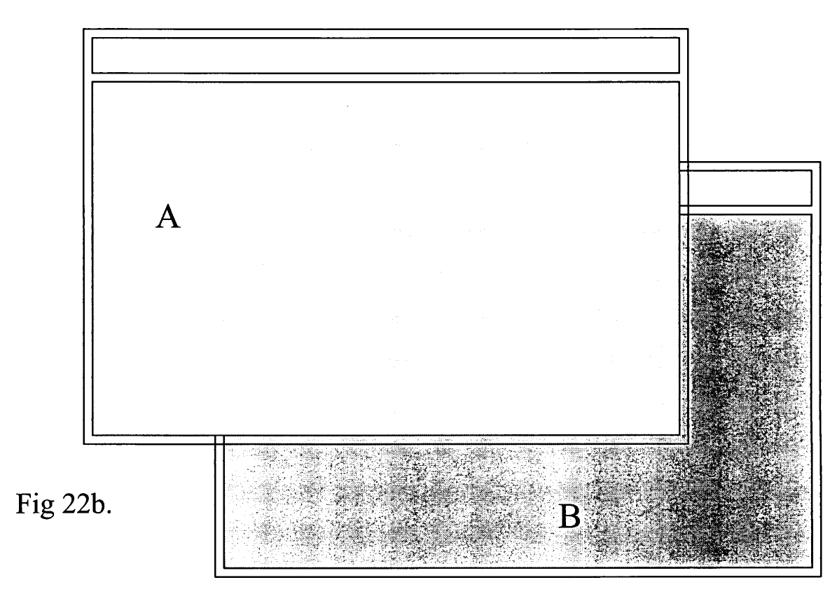

In this embodiment properties and behavior of individual frames (FIG. 5a) may be specified at form creation or manipulated at run time by user or content messages including—dragging/moving of the frames (FIG. 21), the ability to change the visible order of frames (FIGS. 22a and 22b), closing, resizing, minimizing and maximizing/restoring the frame and setting its visible position and/or setting the frame's desktop number (FIG. 19), and the frame's properties—all detailed below;

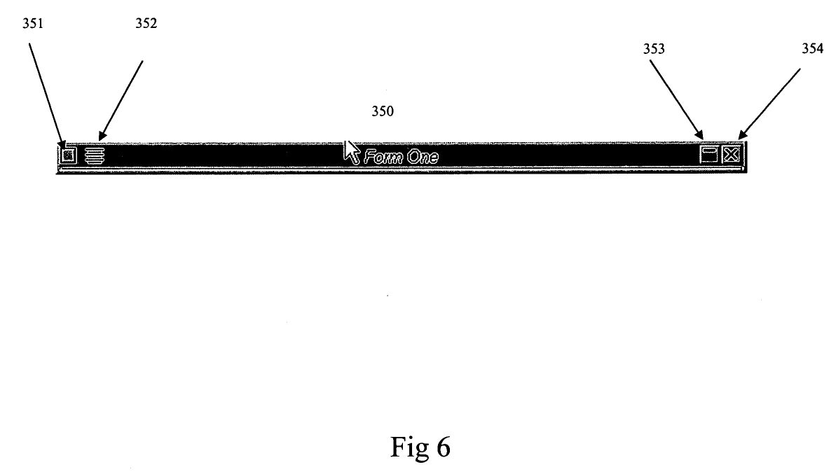

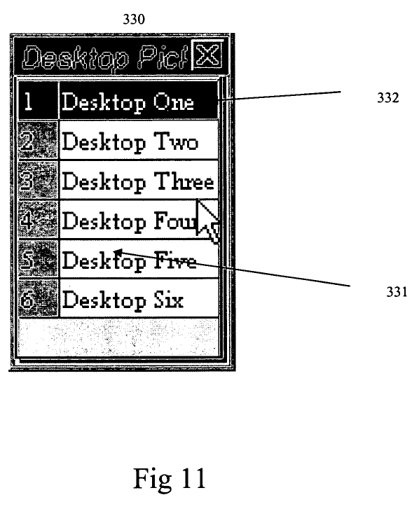

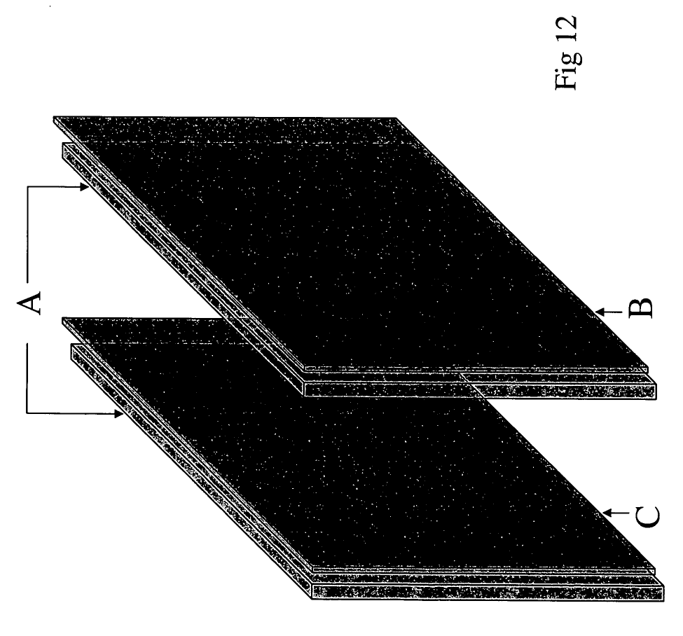

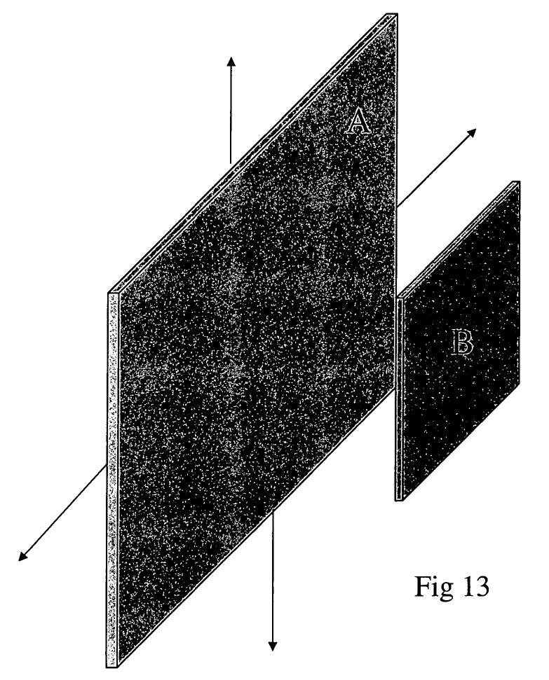

In FIG. 17 each Normal frame (FIG. 17 B) may be moved between the desktop layers. This is demonstrated in this embodiment by the user generating events or using content messages. using the Desktop Picker (FIG. 11). In this embodiment the user may access the GUI Desktop Picker by selecting the Desktop Picker Icon (FIG. 6 352) from the title bar. The user may click on the title bar control (FIG. 6 352) and open the Desktop Picker (FIG. 11) that in this embodiment is a GUI list (FIG. 11 331) containing a record for each desktop available. The user may locate the list line (FIG. 11 332) containing the desktop name or number to move the frame to and by selecting that line (FIG. 11 332) in the list (FIG. 11 331) the frame will be moved to the selected desktop (FIG. 17c B, C) and the desktop will switch to the one selected from the list becoming the current or top as in (FIGS. 16a and 16b) so that the frame is visible on the selected desktop.

In FIG. 17 behavioral properties of the frame as it relates to the workspace may be changed. This is demonstrated in this embodiment by the user clicking on the control in a frame's title bar (FIG. 6 351) that will change the frame's movement characteristics The frames behavior and properties (FIG. 17) are changed so that the frame toggles between—for this embodiment—two types of frames Special (FIG. 17b) and Normal frames (FIG. 17c). The client form will receive a message just before the frame type is switched.

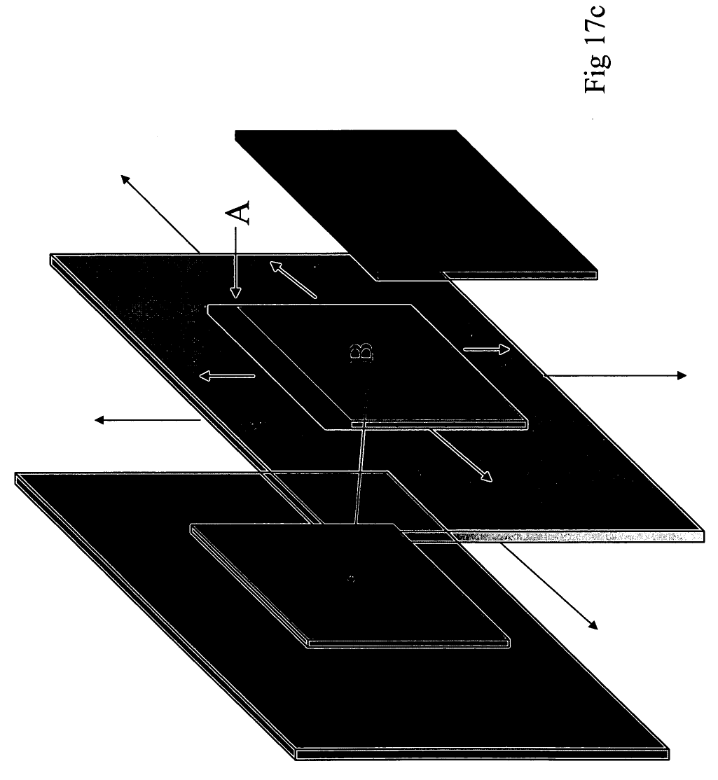

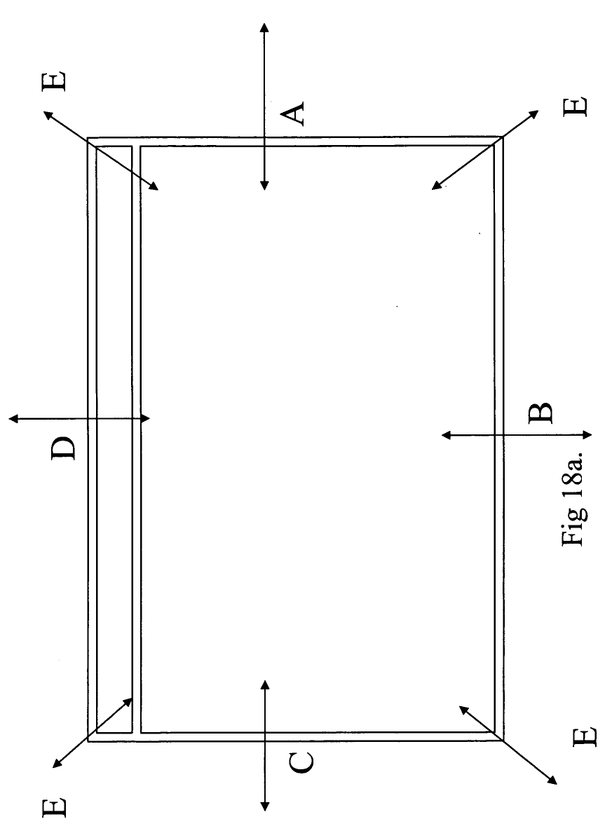

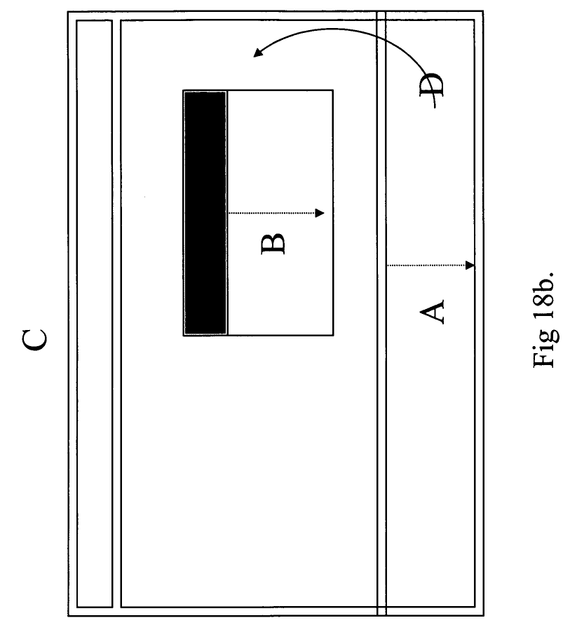

In FIG. 18a the frames may be individually resized. This is demonstrated in this embodiment by the user moving the mouse over any edge (FIG. 5a 502) or any corner (FIG. 5a 503) of any frame so enabled and clicking and holding down the right mouse button and then dragging the selected edge or corner to expand or contract the frame according to the edge or corner being dragged as in FIG. 18a. The client content will receive resizing messages which allow the components to be resized if so enabled (FIG. 18b).

In FIG. 21 the frames location on a desktop layer may be changed by a user or workflow process at run time. This is demonstrated in this embodiment by the user moving the mouse over the title bar (FIG. 5a 500) of any frame and by clicking the right mouse button and holding it down while dragging the frame in any direction as in FIG. 21.

In FIG. 22a the visible order may be changed of frames. This is demonstrated in this embodiment by the user clicking on an underlying frame (FIG. 22a A) to make the frame the topmost (FIG. 22b A). In FIG. 22a the user may click on any part of the underlying frame (FIG. 22a frame A). The frame (FIG. 22a frame B) that was top will be sent a ‘lose focus’ before becoming the underlying frame. The frame (FIG. 22a A) will be sent a ‘to top’ message and then brought to top.

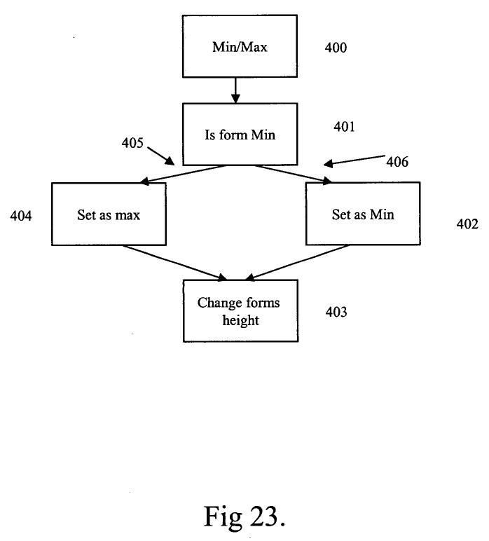

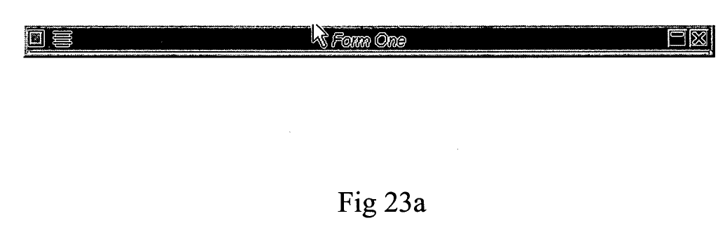

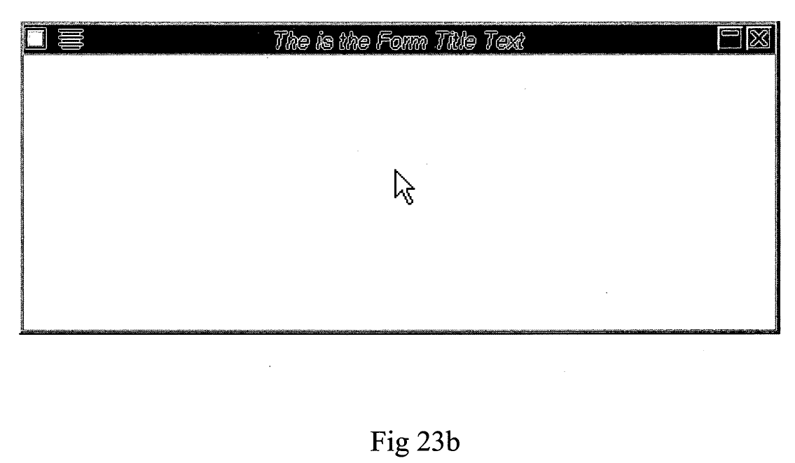

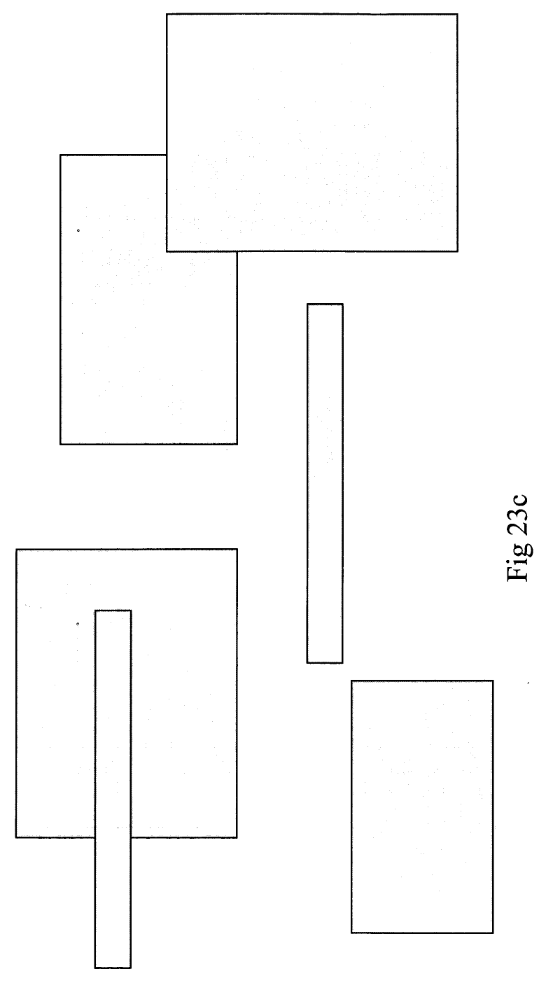

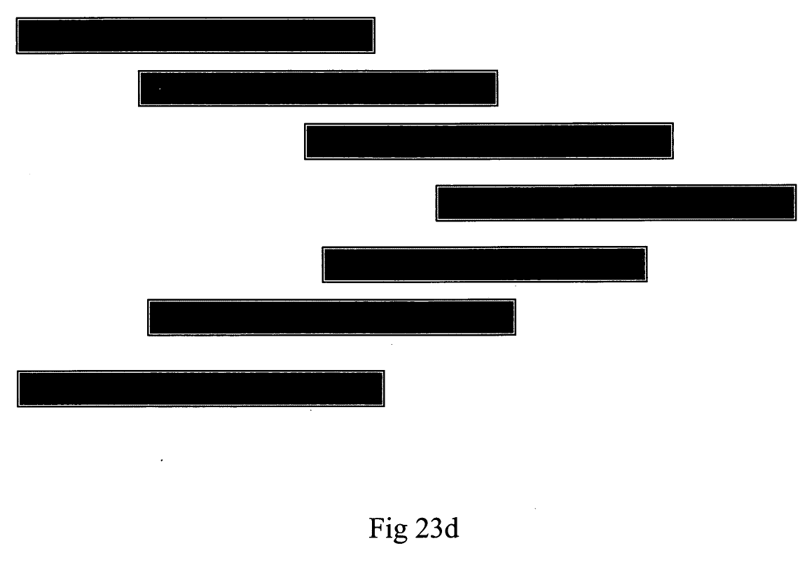

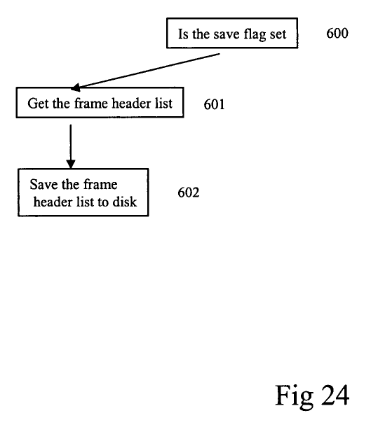

In FIG. 5a the frames may be maximized and minimized and restored. This is demonstrated in this embodiment by the user selecting the minimize/maximize icon (FIG. 6 353) on the frames title bar and if the frame (FIG. 23b) was not minimized, the frame (FIG. 23b) will be minimized to the title bar height (FIG. 23a). If it was minimized (FIG. 23a) it will be restored to its original height before the minimization while remaining in its current position (FIG. 23b) which in this embodiment is the style for the Mackintosh Operating System 9.x, however, in other embodiments it may be according to the client operating system default for a minimized/maximized frames. The client form receives a message just before the form is minimized. Likewise, the client form will receive a message just before the form is maximized as in (FIG. 23 405,406).

In FIG. 23c the frames on a particular desktop may be organized as a group. This is demonstrated in this embodiment by the user selecting the cascade control from the Navigation Bar (FIG. 7 303). The forms that are on the current desktop (FIG. 23c) will be re-organized visually so that they are cascaded and minimized from one corner of the desktop top another. (FIG. 23d). In other embodiments other group display functions may be available including but not limited to, tiling, splitting and merging the separate frames.

System Processes

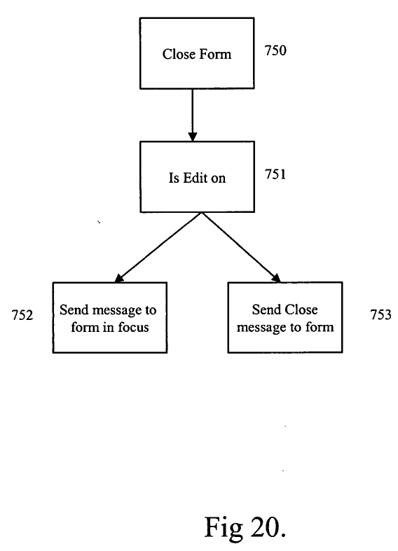

Closing Frames as in Process FIG. 20

The frame may be closed by the user or application at run-time. This is demonstrated in this embodiment by the user clicking on the inbuilt frame close button (FIG. 6 354). The event generated will cause the frame to become invisible or hidden to the user. A message to the client form of the frame before the frame is closed.

Change Frame FIG. 3

New content may be presented into the workspace at run-time. This is demonstrated in this embodiment by the user, through the use of an event to a push button (FIG. 5 316) assign a form from the server to any frame. This will cause the workspace to retrieve the frame header for the form. Using the frame header it will try to find the form in the existing set of open forms in the workspace (FIG. 3 800). If the form cannot be located, the workspace will provide a new frame (FIG. 3 802), apply the frame header properties (FIG. 3 804), load the form into the new frame (FIG. 3 805). Save 4 the frame header (FIG. 3 820), then place the frame containing the content on the desktop layer that was specified (FIG. 3 808). A message is sent to the Workspace Manager with the frame header (FIG. 3. 809) and the frame is brought to top (FIG. 3 811).

If the content is already present in the workspace (FIG. 3 801), and the message is from the Workspace manager then the target content is sent a refresh message (FIG. 3 813). If the frame was closed then the frame is provided with new default opening co-ordinates (FIG. 3 817). If the message was from another form then the frame is sent a message that includes any number or type of parameters (FIG. 3 814) from the calling form. If the form was open the existing co-ordinates (FIG. 3. 818) are when bringing the frame to top (FIG. 3 819). This provides frame to frame and so form to form messaging and allows client forms to send messages to other forms on the client. This is done without the need to send messages to the server.

Frame to External Object Messaging

In this embodiment message may be sent to eternal objects on the client such as Java Applets. In other embodiments this may include but is not limited to Java COM, DCOM Java Script.

Enter Data as in FIG. 4a

Modeless enter data state may be set for the workspace. This is demonstrated in this embodiment by the user clicking the Set Enter Data button (FIG. 4a 362). If the user generates an event in the workspace that attempts to change the modality of the workspace such as clicking on an underlying form (FIG. 4a 360), the system will discard the new event and send a message the frame whose client set the modality (FIG. 4a 361), allowing the frame to respond in by showing an informational message box (FIG. 4a 365).

Off-Line Content Messages

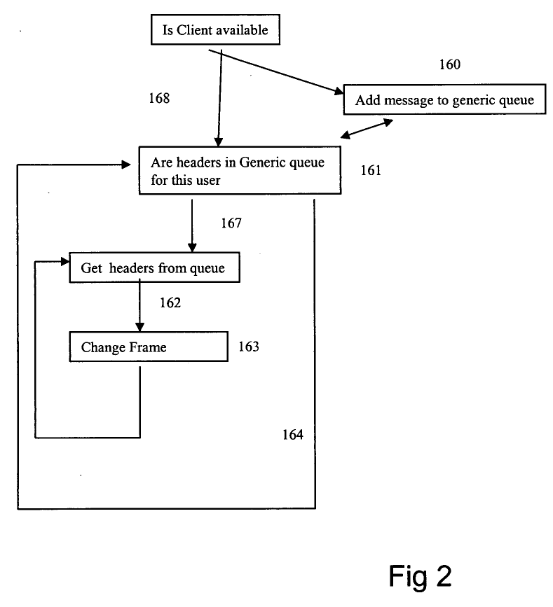

In the invention a generic server based content message queue is created by the system (FIG. 1a 612). The queue is a memory based list containing each content message that has been assigned to a particular user. Content messages for a user may be placed in the queue while the user system is unavailable (FIG. 2 160). If the user's workspace becomes available the content will be transferred to the users queue. The user workspace will then collect and process the content message. (FIG. 2 161).

Asynchronous Messaging

In FIG. 2 frame headers are retrieved and processed asynchronously. In this embodiment the workspace can either check periodically for frame headers in the users queue (FIG. 2 164) or the workspace can be asked by the server to retrieve a newly arrived message (FIG. 2 165). Once the workspace is informed that a message has arrived or detects a message in the user's queue it retrieves each frame header (FIG. 2 162) and passes it to the change frame method (FIG. 2 163).

Starting and Stopping Asynchronous Messages as in FIG. 2

Asynchronous messaging to the user's workspace may be started and stopped. The form Navigation Bar (FIG. 7) contains pushbuttons that are used to access the Asynchronous forms methods (FIG. 7 304,307). The user may toggle the workspace availability (FIG. 7 304). In other embodiments properties and behavior may be specified about the of the asynchronous messaging.

Saving and Rebuilding a Workspace (FIG. 21)

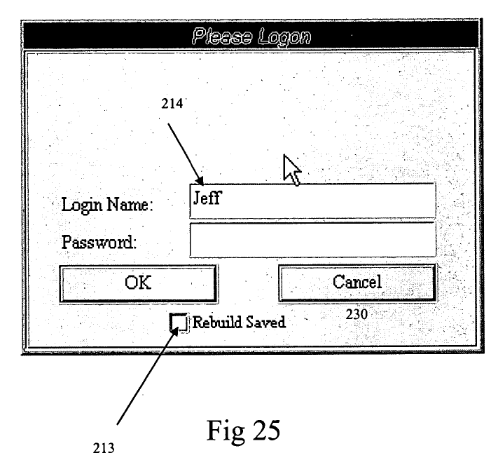

The workspace instance may be saved and retrieved. The user may provide a key (FIG. 25 214) and set a save flag (FIG. 7 306) that will save the users workspace (FIG. 5) instance to disk when the user exists the workspace. As each frame is opened and on each subsequent manipulation within the workspace, its frame header record is first added and then updated in the memory list on the server FIG. 3 820). Setting the save flag (FIG. 7 306) will save the memory list to a storage device (FIG. 1a 614) when the user closes the workspace instance.

Likewise, the user when requesting a saved workspace instance may provide a known key (FIG. 25 214) to a saved instance and set a rebuild flag (FIG. 25 213) The user key used when the forms were saved (FIG. 25 214) is used to retrieve the workspace instance record containing the instance layout and the frame headers for each frame that was active when the instance was saved. When the workspace instance is being reconstructed in the user's browser, frame header messages that are retrieved from storage are processed on the server by the system and sent using synchronous messaging (FIG. 2) to the workspace instance.

The following appendix material presents the key Omnis Studio source code that enables certain key aspects of the invention. One of ordinary skill in the art can reproduce other features of the invention once being presented the points below. The compact disc appendix to the present application further enables all features of the invention.

```
Message parsing;
For count from 1 to 13 step 1
Set reference tree to $cinst.$objs.tree
Do tree.$clearallnodes( )
Calculate obj as xml.$documentelement( )
Do method $getelementtext (obj) Returns nodetext
Set reference treenode to tree.$add(nodetext)
Switch count
    Case 1
Do method $get_frame_header (obj,treenode,iFrameHeaderList,iFormDisplayRow)
    Case 2
Do method $get_frame_header (obj,treenode,iFormControlsList,ivColumnsList)
    Case 3
Do method $get_frame_header (obj,treenode,ivFormThemeList,iFormThemesRow)
    Case 4
Do method $get_frame_header (obj,treenode,ivFormsLibList,iFormsLibRow)
    Case 5
Do method $get_frame_header (obj,treenode,ivTablesList,ivTablesRow)
    Case 6
Do method $get_frame_header (obj,treenode,ivWebDataSetsList,ivWebDataSetsRow)
    Case 7
Do method $get_frame_header (obj,treenode,ivDataSetsList,ivDataSetsRow)
    Case 8
Do method $get_frame_header (obj,treenode,ivDataList,ivDataRow)
    Case 9
Do method $get_frame_header (obj,treenode,iFrameHeaderCtrlList,iFrameHeaderCtrlRow)
    Case 10
Do method $get_frame_header (obj,treenode,iForm Properties,iFormPropsList)
    Case 11
Do method $get_frame_header (obj,treenode,iFormPropertiesList,iForm PropertiesListList)
    Case 12
Do method $get_frame_header (obj,treenode,iFormMethodsList,iFormMethodsListList)
    Case 13
Do method $get_frame_header (obj,treenode,iClassMethodsList,iClassMethodsListList)
    Default
  End Switch
End For
Add and positioin contyent;
Calculate height as pFieldPos.cvHeight
Switch pColumnInfo.ivColumnType
Case kDate
Switch pColumnInfo.ivColumnSublen
Case 2,3,4,5
Calculate displayFormat as kFormatTime
Case 1,9,11
Calculate displayFormat as kFormatShortDate
Case 10,12
Calculate displayFormat as kFormatLongDate
Case 6,7,8,13,14
Calculate displayFormat as kFormatShortDateTime
End Switch
Calculate type as “Single Line Edit”
Case ‘kPicture’
Calculate type as “Picture”
Calculate height as pFieldPos.cvHeight*cvImageHeight
Case ‘kButtonarea’
Calculate type as “Button Area”
Calculate componentlib as “FORMFLDS”
Case ‘kCombo’
Calculate type as “Combobox”
Calculate componentlib as “FORMFLDS”
Case ‘kFormFile’
Calculate type as “FormFile”
Calculate componentlib as “FORMFILE”
Case ‘kGIF’
Calculate type as “GIF”
Calculate componentlib as “FORMGIF”
Case ‘kJPEG’
Calculate type as “JPEG”
Calculate componentlib as “FORMJPEG”
Case ‘kMultiLine’
Calculate type as “Multiline Edit”
Calculate componentlib as “FORMFLDS”
Case ‘kProgress’
Calculate type as “Progress”
Calculate componentlib as “FORMPROG”
Case ‘SingleLineEdit’
Calculate type as “Single Line Edit”
Calculate componentlib as “FORMFLDS”
Case ‘kTransButton’
Calculate type as “TransButton”
Calculate componentlib as “FORMTRAN”
Case ‘kCalendar’
Calculate type as “Calendar”
Calculate componentlib as “FORMCAL”
Case “kDataGrid’
Calculate type as “Data Grid”
Calculate componentlib as “FORMGRID”
Case ‘kFormPort’
Calculate type as “FormPort Control”
Calculate componentlib as “FORMPORT”
Case ‘kHeadingList’
Calculate type as “Heading List”
Calculate componentlib as “FORMFLDS”
Case ‘kList’
Calculate type as “List”
Calculate componentlib as “FORMFLDS”
Case ‘kPagedPane’
Calculate type as “PagedPane”
Case ‘kPushButton’
Calculate type as “Push Button”
Calculate componentlib as “FORMFLDS”
Case ‘kSlider’
Calculate type as “Slider”
Calculate componentlib as “FORMSLID”
Case ‘kUserInfo’
Calculate type as “UserInfo Control”
Calculate componentlib as “FORMINFO”
Case ‘kCheckBox’
Calculate type as “Check Box”
Calculate componentlib as “FORMFLDS”
Case ‘kDropList’
Calculate type as “Droplist”
Calculate componentlib as “FORMFLDS”
Case ‘kFormRoll’
Calculate type as “FORMROLL Control”
Calculate componentlib as “FORMROLL”
Case ‘kHotPict’
Calculate type as “HOTPICT Control”
Calculate componentlib as “FORMHPIC”
Case ‘kMarquee’
Calculate type as “Marquee”
Calculate componentlib as “FORMMARQ”
Case ‘kPicture’
Calculate type as “Picture”
Calculate componentlib as “FORMFLDS”
Case ‘kRadio’
Calculate type as “Radio Group”
Calculate componentlib as “FORMFLDS”
Case ‘kSubForm’
Calculate type as kSubwindow
Calculate componentlib as
Case ‘kWebTree’
Calculate type as “WebTree Control”
Calculate componentlib as “FORMTREE”
Case ‘kClock’
Calculate type as “Clock”
Calculate componentlib as “FORMCLOK”
Case ‘kFadePict’
Calculate type as “Fadepict”
Calculate componentlib as “FORMFADE”
Case ‘kFormTimer’
Calculate type as “FormTimer Control”
Calculate componentlib as “FORMTIME”
Case ‘kIconArray’
Calculate type as “IconArray”
Calculate componentlib as “FORMICON”
Case ‘kMoviePlayer’
Calculate type as “MoviePlayer Control”
Calculate componentlib as “FORMQT3”
Case ‘kPrintingControl’
Calculate type as “Printing Control”
Calculate componentlib as “FORMPRI”
Case ‘kSideBar’
Calculate type as “Sidebar”
Calculate componentlib as “FORMSBAR”
Case ‘kTabbar’
Calculate type as “Tabbar”
Calculate componentlib as “FORMSBAR”
Default
Calculate type as “Single Line Edit”
End Switch
Do method addfield (pColumnInfo,pClass,pFieldPos)
Send form to client (trade secret)
Do $root.$iremoteforms.rfWebFormHost.$sendform
Assign Content
Switch pform_data.form_type
Case 1,3 ;; ‘system’
Do method $api_get_next_system_frame Returns frame_name ;; xxxxxxxxxxxxxxxxx
Case 2 ;; navigation
Do method $api_get_next_navigation_frame Returns frame_name ;; xxxxxxxxxxxxxxxxx
Case 3 ;; service
Do method $api_get_next_service_frame Returns frame_name ;; xxxxxxxxxxxxxxxxx
Case 4 ;; application
Do method $api_get_next_application_frame Returns frame_name ;; xxxxxxxxxxxxxxxxx
Default
End Switch
Quit method frame_name
Fit frame and position on desktop
Calculate framepage_name as pframepage_name
Do $cwind.$objs.[framepage_name].$height.$assign(0)
Do $cwind.$objs.[framepage_name].$width.$assign(pform_hw_data.form_width)
Do method $cwind.$get_pan_top Returns pan_top
Do method $cwind.$get_pan_left Returns pan_left
If pan_top>pform_tl_data.form_top
Do $cwind.$objs.[framepage_name].$top.$assign(pan_top+30+pform_tl_data.form_top)
Else
Do $cwind.$objs.[framepage_name].$top.$assign(pform_tl_data.form_top)
End If
If pan_left>pform_tl_data.form_left
Do $cwind.$objs.[framepage_name].$left.$assign(pan_left+50+pform_tl_data.form_left)
Else
Do $cwind.$objs.[framepage_name].$left.$assign(pform_tl_data.form_left)
End If
Do $cwind.$objs.[framepage_name].$height.$assign(pform_hw_data.form_height)
```

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A remote process or user driven content component creation, delivery, presentation and storage system communicating over TCP/IP, said system comprising:
a. a browser based client module providing a client workspace comprising of a graphical user interface supporting a plurality of moveable frames and layered desktops within a single browser window and component execution and event management services; and
b. and a server based module providing dynamic form based content component creation, storage and delivery services to the client workspace.

2. The system of claim 1 wherein a content component creation engine delivers pre-built components and the system exposes a public application programmer's interface that allows creation of components that can be used in creating form content, and wherein components written to interface specifications can be manipulated by the system and the content messages, preferably wherein a public interface allows submission of form creation specification documents, preferably wherein the interface is a cross-platform highbred of C and C++ and Java, and optionally wherein interface support comprises all programming and scripting languages components capable of having their behavior defined by programming language code and have data access and services provided by the system.

3. The system of claim 2 here said content can be specified by a XML document.

4. The system of claim 3 wherein said delivery services between said client and said server modules is over TCP/IP and comprises directory services, synchronous messaging, data and content transfer and multiple content specific communications and asynchronous messaging.

5. The system of claim 4 wherein said delivery services and said XML document can modify said system and said system components at run-time.

6. The system of claim 4 wherein said XML document can specify a multiplicity of content types, standard and custom properties, standard and custom behavior that can be specified by preferably selected from the group consisting of the list of types, properties events and behavior beginning on page 15 of the specification.

7. The system of claim 5 wherein said content types can be added to via an available developer application programming interface.

8. The system of claim 4 wherein said XML document can specify for said frames a plurality of display properties preferably one or more of the properties selected from the group consisting of Title Bar, Title Bar Text Alignment, Title Bar Text Font, Title Bar Text Font Size, Title Bar Text Font Style, Title Bar Text Color, Title Bar Height, Title Fore Color, Title Bar Gap Size, Title Bar Inner Border, Title Pattern, Title Back Color, Frame Inner Border, Frame Outer Border, Frame Gap Fill Color, Frame Gap Size, Frame Width, and Frame Height.

9. The system of claim 4 wherein said XML document can specify for said frames a plurality of behavioral properties preferably selected from the group consisting of Can Drag/Move, Can Resize, Disable Content Sizing, Bring to Top, Can Be Attached to a Form or Component, Edge Float, Minimizing, and Maximizing.

10. The system of claim 4 where said XML document can specify for said content, data access, and theme and data storage options.

11. The system of claim 4 wherein said XML document can specify for said desktops a plurality of display, behavioral, dynamic and content specific properties preferably including one or more of the properties selected from the group consisting of Current Visible Desktop Number, Desktop Height, Desktop Width, Visible Desktop Area, Name, Fore Color, Border Color, Pattern, Border Effect, and Desktop Image.

12. The system of claim 1 wherein said desktops' visible desktop area viewable by the browser may be changed.

13. The system of claim 1 additionally comprising virtual desktops inside the browser window with a size alterable by the user.

14. The system of claim 1 wherein said desktops are displayed in said window according to a front and back order wherein a desktop towards the front in the order overlaps any desktops farther back in the order, and wherein said order may be altered.

15. The system of claim 1 wherein said plurality of desktops can be assigned individual themes.

16. The system of claim 1 wherein said frames can be dragged by the user to appear at a different location within said browser window.

17. The system of claim 1 wherein said frames can be resized by the user.

18. The system of claim 1 wherein said frames can be minimized in their current location by the user.

19. The system of claim 1 wherein said frames can be maximized in their current location by the user.

20. The system of claim 1 wherein said frames can be independently closed by the user.

21. The system of claim 1 where said frames being displayed in said window according to a front and back order wherein a frames towards the front in the order overlaps any frame farther back in the order which are displayed in a same area of said window, wherein said order may be altered by a user of the browser.

22. The system of claim 1 wherein one or more frames can be fixed to a location in a visible space of said browser window during scrolling of the virtual desktop.

23. The system of claim 1 additionally comprising a plurality of layered desktops of the browser window between which the user may set the desktop layer on which the frame resides.

24. The system of claim 1 wherein said frames' content may be populated asynchronously from server based content queues.

25. The system of claim 1 additionally comprising a set of services allowing said frames to exchange messages on the client.

26. The system of claim 1 additionally comprising a set of services allowing presentation properties of groups of frames to be accessed as unit.

26. The system of claim 1 additionally comprising a set of services allowing said frames to exchange messages with other non workspace or external objects

27. The system of claim 1 additionally comprising a set of services allowing presentation properties of groups of frames to be accessed as unit.

28. The system of claim 1 wherein said workspace may be saved to said storage.

29. The system of claim 1 wherein desktops and said frames and their contents may be restored from a saved record.
